(19) United States
(12) Patent Application Publication
(10) Pub. No.: US 2025/0124502 A1
(43) Pub. Date: Apr. 17, 2025

(54) AUTOMATED SYSTEM AND METHOD FOR DETECTING DATA DISCREPANCIES

(71) Applicant: Lancaster Systems, LLC, Penngrove, CA (US)

(72) Inventors: Frank Philip Antonini, Cotati, CA (US); Jake James Walsh, Sonoma, CA (US)

(21) Appl. No.: 18/380,550

(22) Filed: Oct. 16, 2023

(51) Int. Cl. G06Q 40/03

(52) U.S. Cl. CPC G06Q 40/03

(57) ABSTRACT

A computer-implemented method for detecting mortgage discrepancies compares original mortgage terms to updated public records to identify discrepancies. Mortgages are automatically categorized into tiers indicating a likelihood of violation based on discrepancies. A list of mortgages organized by violation likelihood tier is displayed. Upon user selection of a mortgage, it is assigned for investigation. The status is tracked as the user investigates discrepancies. The status is updated based on resolution activities. Final resolution results comprising renegotiated or refinanced mortgages are recorded. The method periodically queries public records to retrieve updated property data for comparison against original mortgage terms to identify discrepancies efficiently. Discrepancies are categorized by severity to prioritize investigation.

### BACKGROUND

Mortgage lenders face inherent risks due to uncertainty about the future financial stability of borrowers. However, lenders currently have limited visibility into changes in ownership of the mortgaged property over the life of the loan. For example, borrowers may transfer or modify the deed without notifying the lender, removing the lender's ability to reassess risk. This lack of visibility also impacts lenders when interest rates rise, forcing them to pay more for new borrowing while still collecting previous loans at lower rates.

The Garn-St. Germaine Depository Institutions Act of 1982, a significant legal development, sought to tackle the aforementioned issues related to the Due-on-Sale clause. This Act played a crucial role in solidifying the legality of the Due-on-Sale clause, empowering mortgage lenders with the ability to demand full repayment of the mortgage loan if the clause is violated. However, in practice, lenders heavily rely on borrowers to disclose any transfers of ownership, which can be an inconsistent and unreliable process. Unfortunately, this often means that lenders remain unaware of potential violations, as borrowers may fail to report such changes or may intentionally keep them hidden. A manual system of checking county records for each individual mortgage is an inefficient and impractical approach to uncovering such violations. The colossal number and complexity of these records make it arduous for lenders to perform thorough and timely checks. Consequently, this creates a significant challenge for lenders, as violations can easily go undetected, leading to adverse consequences for their portfolios.

Further, the untimely discovery of the unapproved deed transfer or modification limits both the lenders' and borrowers' ability to establish mutually beneficial terms when a renegotiation may be helpful.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure may be deployed, in accordance with some examples.

FIG. 2 shows a block diagram of the automated mortgage discrepancy detection system and its component subsystems, according to some examples.

FIG. 3 is an entity relationship diagram showing data structures, according to some examples.

FIG. 4 is a flowchart showing overall operations, according to some examples.

FIG. 5 is a flowchart showing manual contract data upload, according to some examples.

FIG. 6 is a flowchart showing automated contract data ingestion, according to some examples.

FIG. 7 is a flowchart showing payment data upload, according to some examples.

FIG. 8 is a flowchart showing public data access operations, according to some examples.

FIG. 9 is a flowchart showing tier classification, according to some examples.

FIG. 10 is a flowchart showing lead workflow management, according to some examples.

FIG. 11 is a state diagram showing status transitions, according to some examples.

FIG. 12 is a user interface diagram showing statistics summary interfaces, according to some examples.

FIG. 13 is a user interface diagram showing a refinance statistics interface, according to some examples.

FIG. 14 is an interface diagram showing monthly renegotiation interfaces, according to some examples.

FIG. 15 is an interface diagram showing renegotiation event interfaces, according to some examples.

FIG. 16A is an active leads interface showing lead lists, according to some examples.

FIG. 16B is an active leads interface showing mortgage comparison, according to some examples.

FIG. 17 is a user interface diagram showing a mortgage repository interface, according to some examples.

FIG. 18 is a user interface diagram showing a mortgage repository interface with actions, according to some examples.

FIG. 19 is a user interface diagram showing a settings interface, according to some examples.

FIG. 20 illustrates a machine-learning pipeline, according to some examples.

FIG. 21 illustrates training and use of a machine-learning program, according to some examples.

FIG. 22 is a block diagram showing a software architecture within which the present disclosure may be implemented, according to some examples.

FIG. 23 is a diagrammatic representation of a machine in the form of a computer system within which a set of instructions may be executed for causing the machine to perform any one or more of the methodologies discussed herein, in accordance with some examples.

### DETAILED DESCRIPTION

Examples disclose systems and methods for automated detection of discrepancies between original mortgage contract terms and updated public records indicating potential unauthorized changes violating mortgage agreements.

A database/data store stores mortgage data including original loan terms, borrower identities, property details, and payment histories for a plurality of mortgages. Public records are periodically queried via external APIs to retrieve updated property and ownership records for comparison.

A discrepancy detection module programmatically analyzes mortgage fields pre-specified as identity and status indicators. It identifies discrepancies by matching and comparing original mortgage data to retrieved public records.

A tiering module categorizes discrepancies into severity tiers indicating a likelihood of contractual violation based on domain expertise encoded in tiering rules. Tier 1 reflects a high violation probability while Tier 3 indicates low risk.

A graphical user interface displays mortgage leads organized by tier. Users select leads to investigate discrepancies. The system assigns leads to users based on workload-balancing algorithms that determine individual user capacity.

The interface tracks lead status as assigned users investigate discrepancies and determine resolution activities. Statuses include potential, investigating, closing, and closed. Status timelines are logged throughout the process.

Investigation outcomes are recorded as renegotiated contracts or fully refinanced mortgages. Closure data includes new terms, principals, interest rates, timelines, and associated profits.

Some examples feature payment data ingestion and discrepancy detection against payment histories. Notifications alert users of detected discrepancies. AI/ML components enhance discrepancy classification, query optimization, and analytics.

Some examples provide efficient identification of unauthorized mortgage changes through automated public records comparison combined with severity tiering, user assignment, status tracking, and resolution recording. This enables proactive monitoring at scale to protect lender interests and prevent detrimental violations.

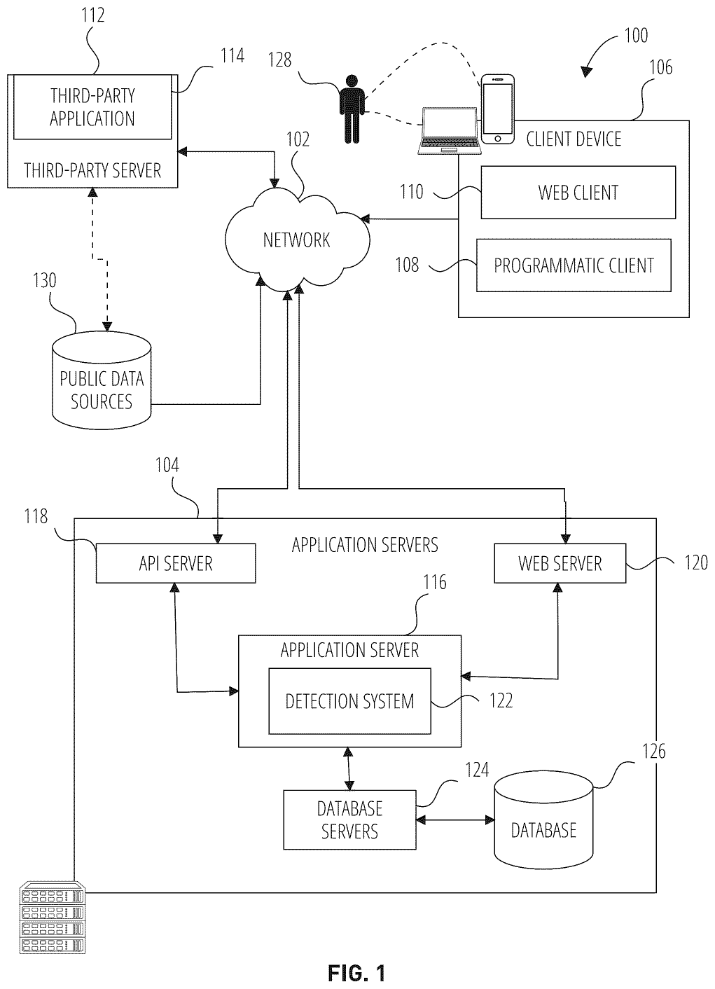

FIG. 1 shows a networked computing environment 100 for an automated mortgage discrepancy detection system 122, according to some examples. The networked computing environment 100 includes various connected servers, applications, databases, and client devices.

One or more application servers 104 provide server-side functionality via a network 102 to client devices 106 accessed by users 128. The client devices 106 host a web client 110 like a web browser and a programmatic client 108 like a mobile or desktop app. These clients allow users to interact with the system.

The application servers 104 include an Application Program Interface (API) server 118 providing programmatic interfaces, and a web server 120 providing web interfaces (e.g., to a web client 110). A specific application server 116 hosts the automated mortgage discrepancy detection system 122 and its components.

The web client 110 communicates with the discrepancy detection system 122 via the web interface and web server 120. The programmatic client 108 communicates via the API Application Program Interface (API) server 118. External third-party applications 114 and public data sources 130 (e.g., public records databases) also accessible by the detection system 122 via the Application Program Interface (API) server 118.

The application server 116 couples to database servers 124, providing access to database 126 containing client mortgage data, payment data, discrepancy analysis data, generated reports, and other data used by the detection system 122.

External third-party applications 114 executing on third-party servers 112 also communicate the discrepancy detection system 122 via the Application Program Interface (API) server 118. For example, a public records third-party application 114 can retrieve property data from public data sources 130 in order to get updated public records.

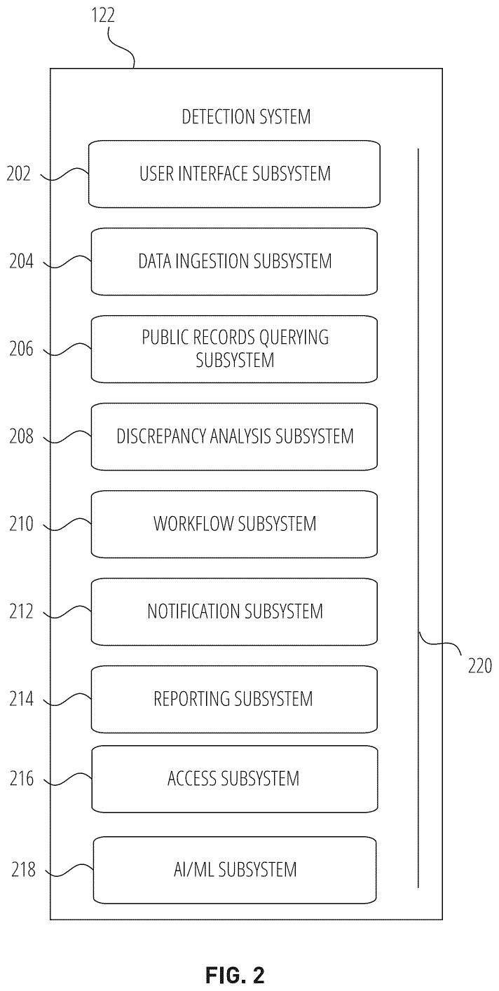

The discrepancy detection system 122 includes a number of subsystems or components, which are described below with reference to FIG. 2.

The automated mortgage discrepancy detection system 122 and its components work together to ingest client data, query external databases, identify discrepancies, categorize and notify users of discrepancies, and generate reports to allow rapid identification of potential violations for further investigation. The system provides a scalable solution for mortgage lenders to gain visibility into changes in ownership and transfers related to their mortgages.

Additionally, a third-party application 114 executing on a third-party server 112, has programmatic access to the application server 116 via the programmatic interface provided by the Application Program Interface (API) server 118. For example, the third-party application 114, using information retrieved from the application server 116, may support one or more features or functions on a website hosted by a third party.

FIG. 2 shows a block diagram of the automated mortgage discrepancy detection system 200 and its component subsystems, according to some examples.

The user interface subsystem 202 handles user interactions with the detection system 122. It generates customized user interface screens based on user type and role. The interfaces allow users to configure system settings, upload mortgage and payment data, view notifications, generate reports, and more. Programming logic dynamically builds interface screens, maps user inputs to actions, and displays outputs.

A data ingestion subsystem 204 provides interfaces for users to upload mortgage contract data and related payment data. It maps incoming data to appropriate data models within the detection system 122, validates the data, and stores validated data in repositories like a client data repository and payment data repository. The data ingestion subsystem 204 contains programming logic to parse uploaded data files, fill gaps, confirm data integrity, and securely save data for storage.

A public records querying subsystem 206 handles querying external public records databases to retrieve updated property and ownership records related to the client's mortgages. It uses mortgage identifiers to query public records and get the latest data for comparison. The public records querying subsystem 206 abstracts the complexity of interacting with public records systems behind a common interface. It also optimizes queries based on past performance.

A discrepancy analysis subsystem 208 performs comparisons between original mortgage contract data and updated public records to identify discrepancies indicating potential violations. To this end, the discrepancy analysis subsystem 208 analyzes relevant fields and applies configurable rules to categorize the likelihood each case represents a violation. Advanced algorithms accurately determine violation probability.

The notification subsystem 212 generates notifications through the interface and email to alert users of detected contract discrepancies. It maintains a history of past notifications. The subsystem allows configuring notification rules based on discrepancy severity, user roles, and other factors. It delivers notifications through appropriate channels.

A notification subsystem 212 compiles identified discrepancy data over time into various visualizations and reports. Users can generate high-level aggregated reports or drill down into case details. The subsystem transforms raw data into charts, graphs, and other visuals for easy interpretation.

The automated mortgage discrepancy detection system 122 further comprises an AI/ML subsystem 218 that leverages artificial intelligence and machine learning algorithms to enhance the capabilities of the detection system 122.

The AI/ML subsystem 218 trains machine learning models on relevant data from the client data repository 202 and payment data repository 204, including both original mortgage contract data and updated public records data. By analyzing this data, the AI/ML subsystem 218 develops models that can categorize and classify different types of discrepancies and anomalies.

For example, the AI/ML subsystem 218 may develop a mortgage discrepancy classification model that can analyze a detected discrepancy between an original mortgage contract and updated public records and determine the likelihood that the discrepancy represents a violation of contract terms. This classification model can then be integrated into the discrepancy analysis subsystem 208 to augment and enhance the subsystem's capabilities.

Additionally, the AI/ML subsystem 218 may further generate models for optimizing the queries made by the public records querying subsystem 206. By training on past query performance data, the AI/ML subsystem 218 can construct models to tune query parameters for optimal efficiency and cost-effectiveness.

The AI/ML subsystem 218 can also detect patterns and trends in aggregated discrepancy data over time. These insights can then be provided to the reporting subsystem 214 to enhance generated reports with machine-learned intelligence.

Furthermore, the AI/ML subsystem 218 may build models that analyze payment data from the payment data repository 204 to identify anomalies that may indicate potential violations. This complements the payment data analysis features of the detection system 122.

The AI/ML subsystem 218 thus leverages artificial intelligence and machine learning techniques to train models on relevant data, integrate those models into various system components to enhance their capabilities, and continuously monitor and retrain models to improve performance over time. This provides an additional layer of intelligence to the automated mortgage discrepancy detection system 122.

Together, these subsystems allow automated ingestion of client data, identification of mortgage contract discrepancies, notification of users, and reporting on discrepancies over time. The system provides scalable and rapid detection of potential violations.

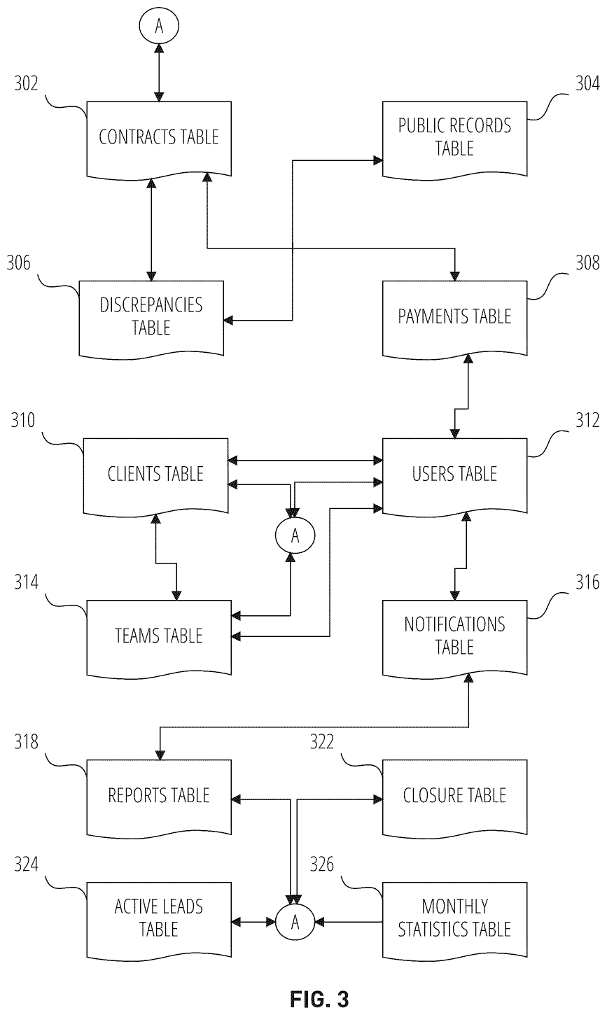

FIG. 3 is an entity relationship diagram illustrating data structures, according to some examples, utilized by the automated mortgage discrepancy detection system 122 and stored with the database 126.

A contracts table 302 stores information about the original mortgage contracts uploaded by clients into the system. Fields include:
ContractID—A unique alphanumeric identifier assigned to each contract record that serves as the primary key to identify and access that contract's information in the database table.
ClientID—A foreign key field containing the ID value matching the primary key of the client record in the clients table that uploaded this contract. Allows linking the contract to the relevant client.
Property Address—The full street address of the physical property associated with this mortgage contract, including street number, street name, unit number, city, state, and zip code.
OwnerName—The full legal name(s) of the individual(s) or entity listed as the legal owner(s) of the property associated with this mortgage contract. It could contain one or more names.
InterestRate—The annual interest rate percentage charged on the mortgage loan amount, expressed as a decimal number. For example, 5% would be 0.05.
LoanAmount—The total principal amount borrowed through the mortgage loan, expressed in dollars. Does not include interest or fees.
LoanStartDate—The calendar date on which the mortgage loan and associated contract entered into force and the loan funds were disbursed to the borrower. The start of the loan repayment term.
LoanEndDate—The calendar date on which the final payment on the mortgage loan is expected to be made, completing the repayment term and closing out the contract, assuming no prepayments or defaults.
belongsToTeam—A foreign key field containing the ID of the team record in the teams table that this contract is assigned to for monitoring and processing. Allows linking contracts to relevant teams.
apn—The Assessor's Parcel Number, a unique identifier assigned to each property by a municipal assessor's office for tax assessment and ownership tracking purposes.
mortgageType—Categorizes the type of mortgage such as fixed-rate, adjustable-rate, interest-only, FHA, VA, etc. Determines certain terms.
mortgageTerm—The length of the mortgage contract's repayment period in years, starting from LoanStartDate. Common terms are 15 or 30 years.
borrowerOneName—The full legal name of the first individual listed as a borrower on the mortgage contract.
borrowerOneCreditScore—The credit score of the first borrower when the contract was originated, which determines loan terms. Typically, a FICO or VantageScore.
borrowerTwoName—The full legal name of the second individual also listed as a borrower on the mortgage contract, if applicable.
borrowerTwoCreditScore—The credit score of the second borrower when the contract was originated, if applicable.
originationDate—The calendar date on which the mortgage contract was originated and signed by the borrower(s) to obtain the loan amount. This may precede the LoanStartDate.
endDate—The expected final calendar date on which the last payment is to be made to complete the loan repayment term and satisfy the contract. Same value as LoanEndDate.
downPaymentPercent—The percentage of the property purchase price that the borrower(s) paid upfront when the property was acquired, reducing the required loan amount.
originalLoanAmount—The total principal amount borrowed by the borrower(s) upon the origination of the mortgage contract. Same as LoanAmount.
originalInterestRate—The annual interest rate percentage charged on the original mortgage contract at origination.
monthlyPayments—The scheduled dollar amount owed by the borrower(s) each month to satisfy the payment terms of the mortgage contract. Applies to principal and interest.
originalTotalDue—The total of principal, interest, and fees owed over the full mortgage term, as determined at origination per the contract's terms.
originalInterestDue—The total interest amount owed over the full mortgage term, as determined at origination based on the contract's original interest rate.
lastAdjustmentDate—If the contract has been refinanced or renegotiated through the system previously, this contains the most recent date such an adjustment occurred.
lastAdjustmentType—If applicable, stores whether the last adjustment to the contract carried out through the system was a refinancing event or a renegotiation.

A public records table 304 table contains updated property and ownership records retrieved from public databases and government agencies. Example fields may include:
RecordID—Primary key uniquely identifying each record
Property Address—Address of the property
OwnerName—Current owner name
AssessedValue—Assessed value of property for tax purposes
LastSaleDate—Date of last sale/transfer of ownership

The public records table 304 may include a large number of fields that can broadly be categorized as follows:
Property Identification Information: Includes fields like ParcelNumber, StreetAddress, Latitude/Longitude, LegalSubdivisionName, AssessorsMapReference, etc. These uniquely identify and provide the location of a property.
Ownership Details: Includes Owner1/2FullName, Owner1/2LastName, OwnerIsCorporation, etc. Provides information on the legal owners of a property.
Property Attributes: Includes LotSize, Property Type, YearBuilt, ArchitecturalStyle, etc. Describes the physical details and characteristics of a property.
Tax and Assessment Data: Includes AssessedValue, TaxAnnualAmount, Exemptions, etc. Provides property tax and assessment information.
Transaction History: Includes LastSale fields like Price, Date, SellerName, etc. Captures information on recent sales and transfers of the property.
Legal and Zoning Information: Includes Zoning, LandUseCode, TaxLot, TaxBlock, etc. Details official zoning and legal property descriptions.
Financial Metrics: Includes MarketValue, AssessedLandValue, GrossArea, etc. Various financial metrics are associated with the property.
Supplementary Information: Includes CensusTractID, OwnerRights, OwnerOccupied status, etc. Additional descriptive metadata.

Thus, the public records table 304 contains a comprehensive set of fields capturing multiple aspects of a property's identification, attributes, ownership, history, legal status, financials, and supplementary information.

A discrepancies table 306 tracks identified discrepancies between original contract data and updated public records. Fields include:
DiscrepancyID—Primary key to uniquely identify each discrepancy
ContractID—Foreign key linking to original contract table
RecordID—Foreign key linking to public records table
DiscrepancyType—Category of discrepancy detected
DiscrepancyDate—Date discrepancy was detected
Status—Current status of discrepancy records

A payments table 308 stores payment data associated with mortgages. Fields include:
PaymentID—Primary key uniquely identifying payment
ContractID—Foreign key linking to Mortgage Contracts table
PaymentDate—Date payment was made
PaymentAmount—Amount of payment
PayerName—Name of account holder making payment
PaymentAccountNumber—Account number payment originated from

A clients table 310 stores information about companies utilizing the detection system 122. Fields include:
ClientID—Primary key uniquely identifying each client
ClientName—Name of client company
ClientAddress—Address of client company
ClientIndustry—Industry vertical of client

A users table 312 manages user accounts that access the detection system 122. Fields include:
UserID—A unique alphanumeric ID assigned to each user account as the primary key for retrieving records.
ClientID—A foreign key field containing the ID of the client record in the clients table who created this user account. Links user to a client.
FirstName—The first name of the individual that this user account represents.
LastName—The last name of the individual that this user account represents.
Email—The email address used as the login username for this user account.
Password—An encrypted password used for authentication when logging into this user account.
role—Indicates the access permissions privilege level granted to this user account, such as user, admin, super admin, etc. Determines feature access.
team—Foreign key to the team teams table 314 that this user account belongs to. Links user accounts to teams.
fullName—Concatenation of the first and last name fields for display purposes.
closedRefinances—Count of mortgage refinance events closed by this user through the system.
closedRenegotiations—Count of mortgage renegotiation events closed by this user through the detection system 122.
grossProfitNumber—Total dollar amount of gross profit generated by refinances closed by this user.
grossProfitPercent—Percentage of total team gross profit generated by this user's closed refinances.
lastRenegotiation—Date that this user last closed a renegotiation event.
renegotiationFrequency—Average number of days between this user closing renegotiation events.
lastRefinance—Date that this user last closed a refinance event.
refinanceFrequency—Average number of days between this user closing refinance events.
notifications—List of foreign keys referencing notification records relevant to this user.
investigatingLeads—List of foreign keys for leads assigned to this user currently under investigation.
closingLeads—List of foreign keys for leads assigned to this user currently in the closing stage.
refinanceClosures—List of foreign keys referencing closed refinance events by this user.
renegotiationClosures—List of foreign keys referencing closed renegotiation events by this user.
refinanceMonthlyStats—List of foreign keys referencing monthly statistics records for this user's refinances.
renegotiationMonthlyStat—List of foreign keys referencing monthly statistics records for this user's renegotiations.

A teams table 314 manages teams and access privileges. Fields include:
TeamID—A unique alphanumeric ID assigned as the primary key to identify each team record.
ClientID—A foreign key field containing the ID of the client record in the clients table 310 who created this team. Links teams to a client.
TeamName—A name identifier for the team displayed in the user interface.
Members—An array of foreign key fields containing the IDs of user records associated with this team. Allows linking team records to their member user accounts.
defaultInterest—The default annual interest rate percentage that will be set as the target for potential leads when initially detected. It can be overridden.
defaultTerm—The default mortgage term in years that will be set as the target for potential leads when initially detected. It can be overridden.
defaultDownPayment—The default percentage down payment that will be set as the target for potential leads when initially detected. It can be overridden.
autoInterest—Parameters to integrate with a third-party API to lookup current interest rates to apply as targets rather than a static default rate. Contains partner ID, loan details, property location, etc.
refinanceMonthlyStats—List of foreign keys referencing monthly statistics records for the team's refinances.
renegotiationMonthlyStats—List of foreign keys referencing monthly statistics records for the team's renegotiations.
closedRefinances—Total count of refinance events closed by the team through the system.
closedRenegotiations—Total count of renegotiation events closed by the team through the system.
grossProfitNumber—Total dollar amount of gross profit generated by the team's closed refinances.
grossProfitPercent—Percentage of gross profit generated by the team's closed refinances.
lastRenegotiation—Date the team last closed a renegotiation event.
renegotiationFrequency—Average number of days between the team closing renegotiation events.
lastRefinance—Date the team last closed a refinance event.
refinanceFrequency—Average number of days between the team closing refinance events.
Mortgages—List of foreign keys referencing original contract records uploaded by this team.
inactiveLeads—List of foreign keys for contracts in the queryable pool awaiting next public records check.
potentialLeads—List of foreign keys for detected leads flagged as potential violations requiring review.
investigatingLeads—List of foreign keys for leads assigned for further investigation by the team.
closingLeads—List of foreign keys for leads in the closing stage of the remediation process by the team.
refinanceClosures—List of foreign keys referencing closed refinance events by the team.
renegotiationClosures—List of foreign keys referencing closed renegotiation events by the team.

A notifications table 316 tracks notifications generated by the detection system 122. Fields include:
NotificationID—Primary key uniquely identifying notification
UserID—Foreign key linking to Users table
NotificationText—Text of notification message
NotificationDate—Date notification was generated

A reports table 318 tracks reports generated by the detection system 122. Fields include:
ReportID—Primary key uniquely identifying report
ReportName—Name/title of report
ReportDate—Date report was generated
ReportType—Type of report (discrepancy, payment, summary, etc.)

A closure table 322 stores details and metrics associated with leads that have been closed out through either a renegotiation or refinance event using the detection system 122 and may include the following fields:
apn—The Assessor's Parcel Number (APN) identifying the property for which the mortgage was renegotiated or refinanced through the system.
closedMortgage—A foreign key linking to the original contract record in the contracts table 302 that was renegotiated or refinanced to close this lead.
assigneeIds—An array of foreign keys linking to the user records in the users table 312 who were assigned to investigate and close this lead.
outcome—Categorizes whether this closure resulted in a renegotiation or refinance of the original mortgage contract.
closeDate—The calendar date on which the new mortgage terms were finalized and this closure was completed.
originalOriginationDate—The start date of the original mortgage contract before it was renegotiated or refinanced through the system.
originalEndDate—The expected end date of the original mortgage contract before it was renegotiated or refinanced.
originalTerm—The term length in years of the original mortgage contract.
monthsRemaining—The number of months remaining on the original mortgage term at the time of renegotiation or refinance.
yearsRemaining—The number of years remaining on the original mortgage term at the time of renegotiation or refinance.
originalLoanAmount—The total original principal amount of the mortgage contract.
principalRemaining—The amount of principal still owed on the original mortgage when renegotiated or refinanced.
originalRate—The original annual interest rate percentage charged on the mortgage contract.
interestRemaining—The total interest amount still owed on the original mortgage when renegotiated or refinanced.
newOriginationDate—The new start date of the renegotiated or refinanced mortgage contract.
newEndDate—The new expected end date of the renegotiated or refinanced mortgage contract term.
newTerm—The new term length in years of the renegotiated or refinanced mortgage contract.
newLoanAmount—The new total principal amount of the renegotiated or refinanced mortgage contract.
newInterestRate—The new annual interest rate percentage charged on the renegotiated or refinanced mortgage contract.
newInterestDue—The total interest owed over the term of the renegotiated or refinanced mortgage contract.
profitAmount—For refinances only—The dollar amount of profit calculated as the difference between interest due on the old and new mortgages.
profitPercent—For refinances only—The percentage profit calculated between interest due on the old and new mortgages.
teamTotalProfitAmount—For refinances only—The team's total profit from refinances when this refinance closure occurred.
teamTotalProfitPercent—For refinances only—The team's total percentage profit from refinances when this refinance closure occurred.
userTotalProfitAmount—For refinances only—The assigned user's total profit from refinances when this refinance closure occurred.
userTotalProfitPercent—For refinances only—The assigned user's total percentage profit from refinances when this refinance closure occurred.
userPercentTeamTotal—For refinances only—The percentage of the team's total refinance profit that this assigned user was responsible for when this refinance closure occurred.

An active leads table 324 stores and tracks mortgage contracts that have been flagged as having potential violations or discrepancies between the original client data and public records. The active leads table 324 serves as the central repository for managing leads through the investigation and remediation workflow and may include the following example fields:
belongsToTeam—Links the lead to the team record that owns this contract and lead.
belongsToMortgage—Links the lead to the original contract record that was flagged.
status—Tracks the current stage of the lead in the workflow-potential, investigating, or closing.
tier—Categorizes the likelihood of a violation based on the discrepancies found during public records check.
dateDiscovered—Timestamp of when discrepancies were initially detected by querying public records.
apn—The property's APN for tracking and identification.
mortgageType—The type of mortgage such as fixed, ARM, interest-only, etc.
mortgageTerm—The original term length of the mortgage contract.
originalBorrowerNames—Original borrower names on the contract.
borrowerNames—New borrower names found in public records, if changed.
borrowerCreditScores—New credit scores if changed.
originationDate—Original start date of the mortgage contract.
originalEndDate—Original expected end date of the mortgage term.
downPaymentPercent—Original down payment percentage.
remainingMonths—Months remaining on the original term when discrepancies are detected.
originalLoanAmount—Total original principal amount borrowed.
originalTotalDue—Total amount owed over original term.
originalInterestRate—Original annual interest rate percentage.
originalInterestDue—Total interest owed on original contract.
originalMonthlyPayments—Original scheduled monthly payment amount.
flaggedPrincipalPaid—Total principal paid when discrepancies were found.
flaggedInterestPaid—Total interest paid when discrepancies were found.
flaggedPrincipalRemaining—Principal still owed when discrepancies detected.
flaggedInterestRemaining—Interest still owed when discrepancies detected.
targetMortgageTerm—Target term set for potential refinance.
targetInterestRate—Target rate set for potential refinance.
autoInterest—Parameters to lookup current rates from 3rd party API.
targetInterestDue—Target interest owed if refinanced at target terms.
targetMonthlyPayments—Target monthly payments if refinanced.
targetProfitNumber—Dollar amount of profit if refinanced at target vs original.
targetProfitPercent—Percentage profit if refinanced at target vs original.
notes—User notes capturing details throughout the process.
assigneeIds—Users assigned to investigate and process this lead.
dateInvestigating—Date the lead entered ‘investigating’ status.
targetOutcome—Whether the goal is to refinance or renegotiate.
lastAssessment—Date of last renegotiation or refinance through the system.

A monthly statistics table 326 tracks performance metrics on a monthly basis for refinance and renegotiation events, aggregated for both teams and individual users, and may include the following example fields:
belongsToTeam—Foreign key to link stats to a team in the teams table 314, if applicable.
belongsToUser—Foreign key to link stats to a user in the users table 312, if applicable.
outcome—Categorizes stats as pertaining to refinances or renegotiations.
sessionLabel—Date string for displaying the month on charts.
sessionParsed—Date parsed into timestamp for chronological sorting.
quarter—Quarter that this month belongs to, for grouping.
quarterSession—Numeric identifier of this month's position in its quarter.
closedRefinances—Count of refinances closed in this month.
closedRenegotiations—Count of renegotiations closed in this month.
closedRenegotiationsPercentOfTotal—User only—Percent of team's renegotiations closed by this user this month.
closedRefinancesPercentOfTotal—User only—Percent of team's refinances closed by this user this month.
grossProfitNumber—Refinances only—Total profit dollars from refinances this month.
profitNumberPercentOfTotal—User only—Percent of team's refinance profit dollars from this user this month.
grossProfitPercent—Refinances only—Total profit percentage from refinances this month.
profitPercentPercentOfTotal—User only—Percent of team's refinance profit percentage from this user this month.
teamClosedRefinances—User only—Total team refinances closed this month.
teamClosedRenegotiations—User only—Total team renegotiations closed this month.
teamGrossProfitNumber—User only—Total team refinance profit dollars this month.
teamGrossProfitPercent—User only—Total team refinance profit percentage this month.

While the data structures in FIG. 3 have been described using examples of tables in a relational database system, alternative data storage architectures may be utilized for implementing the discrepancy detection system. Some other examples of data stores that could potentially be used include document databases, graph databases, time-series databases, search engines, NoSQL databases, in-memory databases, and blockchain ledgers. Document databases provide flexible schemas for managing JSON-like data, graph databases optimize for highly interconnected data represented as nodes and edges, while time-series databases specialize in timestamped data like payments. Search engines facilitate full-text search and analytics on top of data stores. NoSQL databases come in various non-relational structures like key-value stores to handle unstructured data. In-memory databases offer low latency by storing data in main memory. Blockchain ledgers provide immutable, auditable data through decentralized verification. The automated discrepancy detection system can leverage any combination of the above data architectures based on factors such as performance, scalability, data types, and other architectural requirements.

### Overall Operations

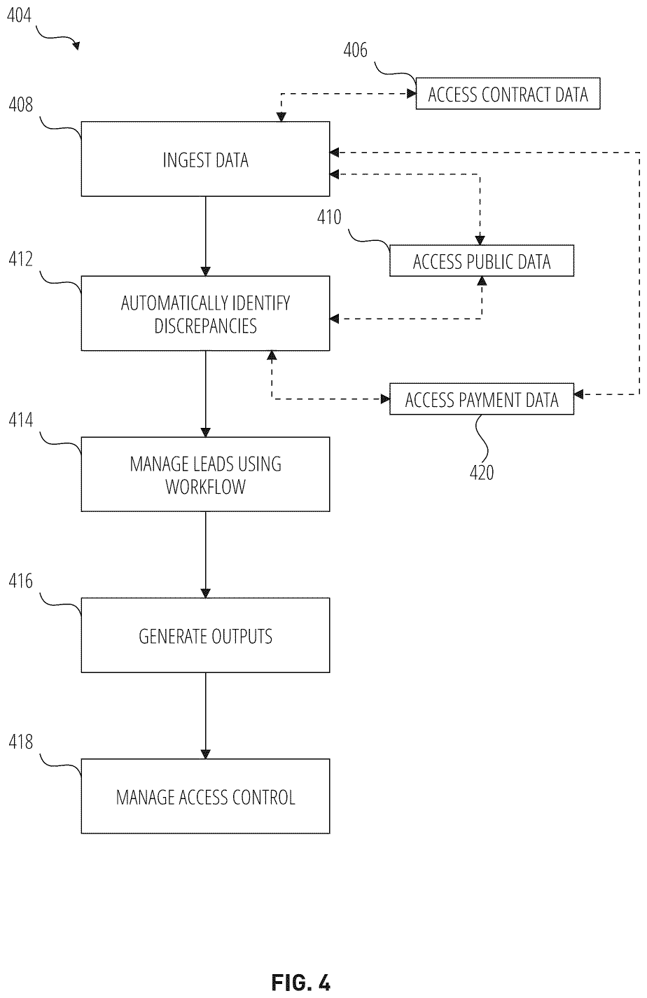

FIG. 4 is a flowchart illustrating a top-level method 404 to automatically detect discrepancies between contract data and public data records as may be performed by detection system 122, according to some examples. The method 404 reflects operations performed by the subsystems of the automated discrepancy detection system 122 and depicts operations taken to ingest data, identify discrepancies, manage workflows, generate outputs, and provide access control. Further and more specific details regarding the sub-operations included in each of these top-level operations are provided with respect to subsequent flow charts.

At block 408, the data ingestion subsystem 204 facilitates the ingestion of data from various sources into the detection system 122 for processing. This includes uploading mortgage contract data and payment data provided by the client (e.g., client data), as well as retrieving associated public records via API queries by the public records querying subsystem 206. The mortgage contract and payment data is stored in tables like contracts table 302, payments table 308, and clients table 310, while public record data is cached for comparison.

At block 412, the discrepancy analysis subsystem 208 then analyzes the ingested data to identify discrepancies between the client data and public records. Discrepancies are categorized, as would be described in more detail below, by the likelihood of violation using the tiering system and supporting tables like the discrepancies table 306. Additional insights like refinance targets and revenue projections are generated as well.

At block 414, the workflow subsystem 210 facilitates managing leads generated from discrepancies using workflows of the workflow subsystem 210. This includes functions like assigning, investigating, and resolving leads by interacting with tables like the active leads table 324, the users table 312, and the teams table 314. Final outcomes are recorded for closed leads in the closure table 322.

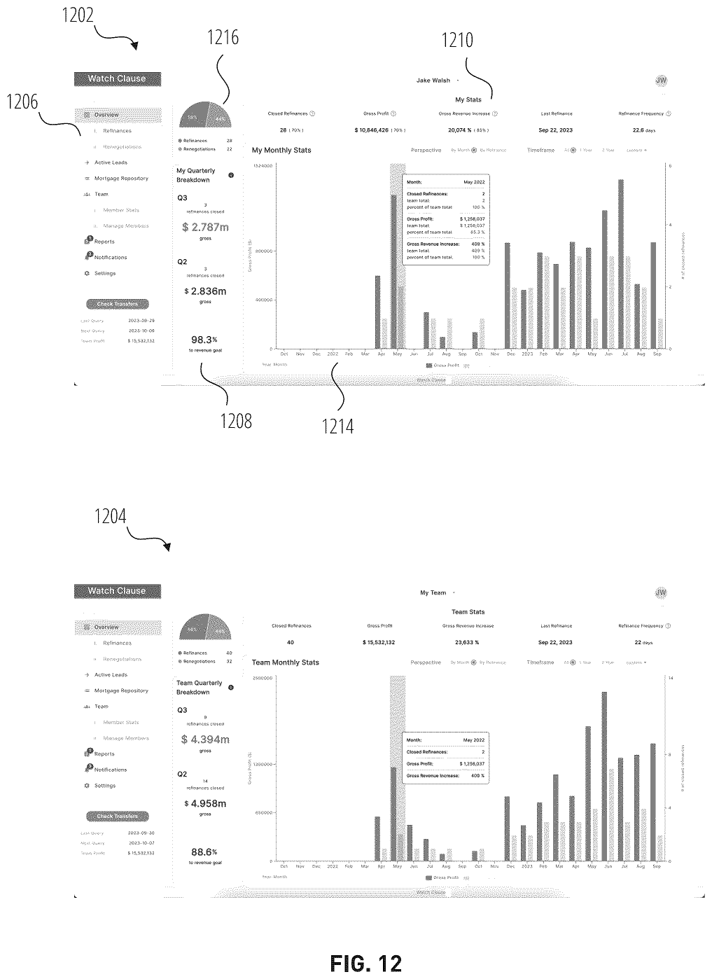

At block 416, the outputs subsystems, including the notification subsystems 212 and the reporting subsystem 214 handle the creation of user interfaces, notifications, and reports to help users leverage the detection system 122 effectively. Frontend UIs display data visualizations, notifications provide alerts on actions, and reports track performance over time. Examples of such UIs are provided and discussed with reference to FIG. 12-FIG. 16B.

Finally, at block 418, the access subsystem 216 handles user authentication via logins and permissions. It also provides API access to programmatically interact with data and operations.

Together, these subsystems work in coordination to deliver the end-to-end automated discrepancy detection workflow.

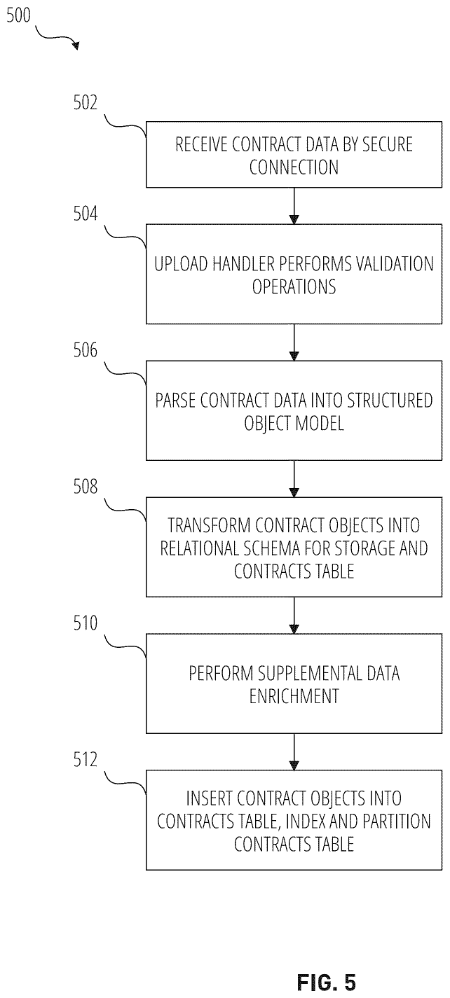

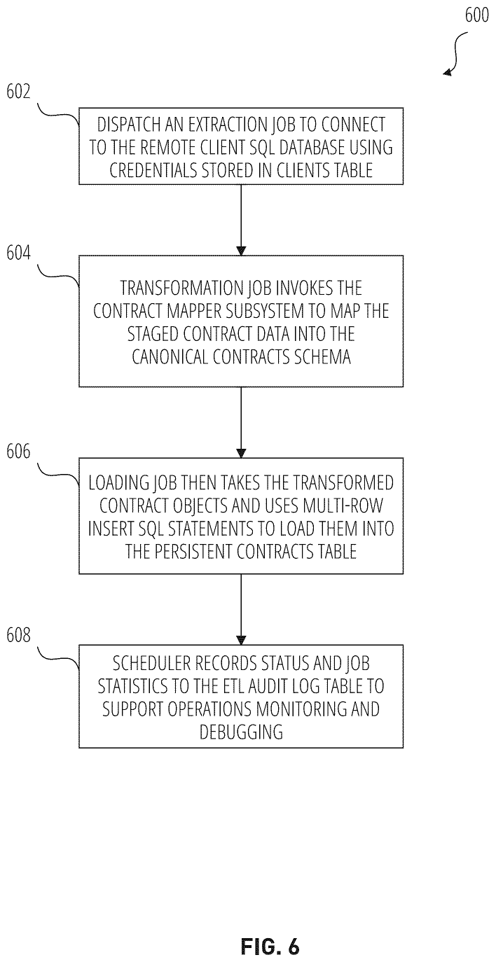

The data ingestion subsystem 204 facilitates loading of contract data (e.g., mortgage contract data) into the database 126 of the detection system 122, enabling downstream processing and analysis. Multiple methods are provided for ingesting this data are supported by the detection system 122, namely an upload of client data is illustrated with reference to FIG. 5, and the automated retrieval of this data from a client database, as described with reference to FIG. 6. When a client first uploads a set of contract data or this data is automatically retrieved, contracts are initialized with a status of ‘inactive’ in the contracts table 302. This indicates they have not yet been checked (or should be rechecked) against public records at block 412. For an initial bulk upload, the data ingestion subsystem 204 assigns an inactive status to each new contract record as it is created and saved to the contracts table 302 of the database 126. When the public records query runs, the public records querying subsystem 206 specifically extracts data for inactive contracts to check for discrepancies. Any contracts found to have potential violations are then marked as ‘potential’ and pulled out into Active Leads.

For subsequent data uploads by the client of contract data, such as corrections or new contracts, the data ingestion subsystem 204 again marks them inactive on insertion to the contracts table 302. This ensures new or updated contracts will get picked up in the next public records query by the public records querying subsystem 206 to have their status validated.

The inactive status therefore acts as a pool of contracts that need their public records checked to determine if their status should be elevated to ‘potential’ or remain inactive if no discrepancies are found. The inactive pool replenishes after each query as contracts with no violations are placed back into it while discrepant ones move to active leads. This status cycling allows regular public records checks on contracts for which records exist in the contracts table 302.

### Manual Contract Data Upload and Processing

FIG. 5 is a flowchart illustrating a method 500 (e.g., corresponding to block 406) to enable access to (e.g., the upload of) client data, an external user interface component, presented via the web server 120, allows client users to upload contact data to the detection system 122, for example as comma-separated values (CSV) files containing mortgage contract data. In some examples, an /upload/mortgages API endpoint provided by the Application Program Interface (API) server 118 facilitates the manual CSV upload workflow. By providing a dedicated API route and associated business logic, the manual CSV upload process can be initiated from any client front-end application that can make authenticated API calls.

The client's CSV file is transmitted to this endpoint along with a unique TeamID identifier. The TeamID is used to query the database 126 to retrieve the number of existing mortgage records already loaded for this client team. This index position may be used when inserting new records to maintain continuous unique numbering.

The contract data is then received at block 502 by the detection system 122. The client's CSV file is transmitted and received over a secure HTTPS connection by an upload handler server-side component.

At block 504, an upload handler server-side component (upload handler) of the data ingestion subsystem 204 implements robust validation, checking the structure, formats, and contents of the uploaded CSV file against expected specifications to prevent malformed input. To enhance the ability of the mortgage contract data to enter the detection system 122, the upload handler implements a comprehensive validation regimen prior to ingesting uploaded CSV files. This validation regimen examines structural, formatting, relational, and business logic aspects of the input data.

At a structural level, the header row and sample data rows are parsed from the uploaded CSV file. The number and positional order of columns is validated against predefined specifications encoding mandatory fields and sequence. CSV files with missing columns or out-of-order columns are rejected to prevent downstream mapping failures.

The upload handler next validates formatting of data within each column using parameterized regular expressions pattern matching and data type casting rules. Date values are checked for proper date formatting, currency values are checked for valid decimal precision, percentages are confirmed to fall within 0-100 range, etc. Records containing improperly formatted data are flagged as invalid and excluded from ingestion.

Further validation encompasses reference data integrity checks. Categorical fields like state codes and status values are confirmed against lookup tables of permitted values. Invalid codes not present in reference tables cause the record to fail validation. Relational integrity validation queries related tables to ensure consistency across records. For example, loan amounts are checked for parity across the contracts table 302 and payments table 308. Violations of relational integrity constraints result in the rejection of inconsistent records. Finally, parameterized business logic validation rules fine-tuned to a client's specific requirements are evaluated. Rules enforcing valid ranges for loan-to-value ratios, debt-to-income ratios, or other custom criteria are applied. Records violating configured business rules are excluded.

This validation process seeks to remove invalid, inconsistent, or non-conforming records from imported CSV mortgage contract data prior to ingestion into the detection system 122, ensuring high data quality and integrity to enable accurate downstream discrepancy detection.

After validation, at block 506, the upload handler parses the raw CSV data into a structured JSON document object model via a streaming Sax-style parser, for example. Each row of the CSV may become a JSON object, with columns mapped to properties.

At block 508, a contract mapper component of the data ingestion subsystem 204 then transforms the JSON mortgage contract objects into the canonical relational schema used within the detection system 122. This maps JSON properties to columns in the contracts table 302 of the PostgreSQL database. Foreign keys to related tables like the clients table 310 are added as well.

At block 510, the data ingestion subsystem 204 performs supplementary data enrichment, for example, deriving missing fields in the contracts schema based on provided data. For example, the annual percentage rate is used to calculate the monthly interest amount to be paid. This normalization and enrichment process may increase data integrity for downstream operations.

Finally, at block 512, the finished contract objects are inserted in bulk into the contracts table 302 using multi-row INSERT SQL statements. This table utilizes indexing and partitioning to optimize storage and retrieval of contracts. The primary auto-generated id column provides each contract with a unique identifier used to link related data across tables.

Once inserted, the new contract data becomes available throughout the system for cross-referencing and discrepancy detection. The user interface displays confirmation of successful data ingestion.

### Automatic Contract Data Upload and Processing

FIG. 6 is a flowchart that illustrates method 600 (e.g., corresponding to block 406) to automatically ingest mortgage contract data from external client databases into the database 126 of the detection system 122, according to some examples. This provides a scheduled, bulk loading workflow alongside an upload, such as the described with reference to FIG. 5.

The automated process is orchestrated by an ETL Scheduler subsystem which is part of the data ingestion subsystem 204 and executes a series of Extract, Transform, Load (ETL) jobs per a configurable cron schedule.

On execution, at block 602, the ETL Scheduler dispatches an Extraction Job to securely connect to a remote client SQL database of a client using credentials stored in the clients table 310. Parameterized SQL queries extract the latest mortgage contract data from the client's database tables into a temporary Staging Area in the discrepancy system database. The Staging Area is partitioned by the client to prevent the commingling of data. Queries are tuned based on profiling the remote database schema to maximize extraction performance. Network encryption protects data in transit.

Next, at block 604, a Transformation Job invokes a Contract Mapper subsystem of the data ingestion subsystem 204 to map the staged contract data into the canonical Contracts schema used internally, enriching any missing fields in the process. The Contract Mapper subsystem accesses reference data from the Lookup Tables to normalize codes and descriptions.

At block 606, a Loading Job of the data ingestion subsystem 204 then takes the transformed contract objects and uses multi-row INSERT SQL statements to load them into the persistent contracts table 302. The contracts table 302 employs partitioning aligned to the Staging Area which enables fast bulk loading. Indexes are efficiently rebuilt after load. Primary keys are auto-generated by the contracts table 302 for unique IDs. Foreign keys to the clients table 310 establish ownership.

Post load, at block 608, the ETL Scheduler records status and job statistics to a ETL Audit Log table (not shown) to support operations monitoring and debugging. Email notifications summarize ingestion results for users.

This scheduled, automated ETL workflow complements manual upload for ingesting contract data from diverse client systems into the centralized repository which powers downstream discrepancy detection.

### Payment Data Upload and Processing

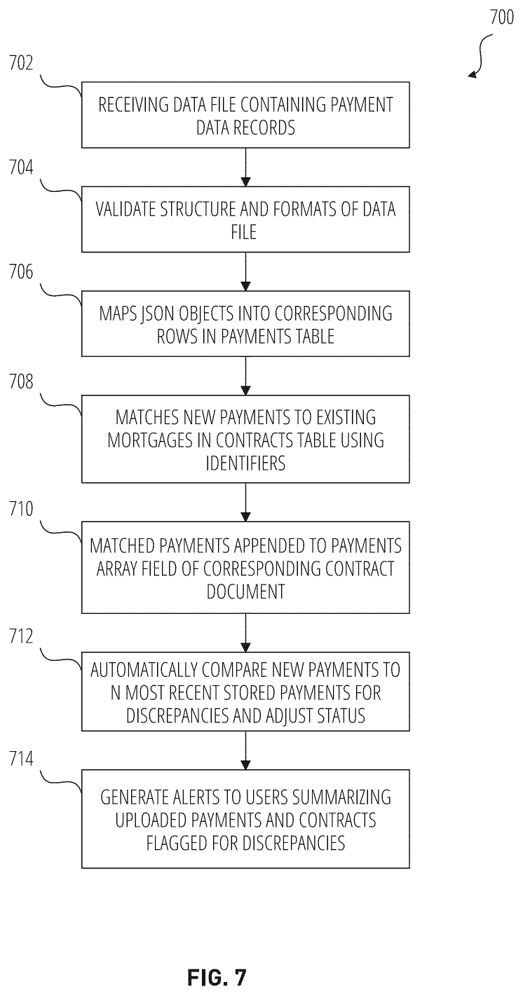

FIG. 7 is a flowchart illustrating a method 700 (e.g., corresponding to block 420) to facilitate the uploading by clients of payment data related to their mortgage contracts for discrepancy detection. This complements the ingestion of contract data itself, described above, and is also part of the data ingestion operations performed at block 408 by the data ingestion subsystem 204.

The method 700 begins at block 702 with the client uploading a CSV file containing payment data records via the/upload/payments API route provided by the Application Program Interface (API) server 118 of the detection system 122. The Application Program Interface (API) server 118 receives the uploaded CSV file over a secure HTTPS connection. The payment data CSV file contains columns representing fields such as:
Assessor's Parcel Number (APN)
Borrower Full Name
Property Address
Payment Amount
Payee Account Number
Payee Routing Number

Sensitive fields like Payee Account Number and Payee Routing Number are encrypted by the client-side interface using asymmetric encryption before transmission to the Application Program Interface (API) server 118. This protects sensitive banking details.

At block 704, the uploaded payment data CSV file is received by a payments upload handler subsystem of the Application Program Interface (API) server 118. The upload handler implements a validation regimen to verify the structure and formats of the payment data CSV file. Structurally, the header row and sample data rows are examined to ensure that predetermined columns like APN, Payment Amount, etc., are present and in the expected sequence. Missing or out-of-order columns will cause validation failure. The data formats within each column are checked using regular expressions and type-casting rules. Payment amounts are confirmed to be correctly formatted decimals. Date values match expected date patterns. Sensitive fields contain properly encrypted data. Invalidly formatted data causes the record to be marked as invalid.

Records passing validation checks are parsed into Payment JSON objects by the CSV parser module of the upload handler. The Parser implements a streaming Sax-style CSV parsing algorithm to efficiently extract each row of the CSV as a JSON object without buffering the entire file contents. The columns of the CSV become properties of the JSON object. For example, the Payment Amount column becomes the “paymentAmount” property. This validation and parsing process extracts and structures valid, properly formatted payment data from the raw CSV upload for further ingestion into the system. Invalid records are excluded to ensure high data quality.

At block 706, the parsed Payment JSON objects are mapped to a schema of the payments table 308 by the Payments Mapper subsystem. The Mapper implements predefined mapping configuration rules that translate the JSON properties into corresponding database columns in the payments table 308. For example, the “paymentAmount” JSON property is mapped to the “amount” column in the payments table 308. The “payeeName” property maps to the “payee_name” column, and so on.

For sensitive fields like the payee account and routing numbers, the Mapper utilizes asymmetric key decryption to temporarily decrypt the values in memory during the mapping process. The decrypted sensitive values are then re-encrypted when inserting into the payments table 308. This keeps sensitive payment details encrypted at rest while enabling schema mapping and downstream matching/comparison logic. The Mapper loads the expected JSON schema and SQL table schemas from the Database Metadata Registry to configure the mapping rules. Reference data from the Lookup Tables is utilized to map invalid codes or abbreviations to normalized descriptions. The result is payment data rows structured according to the canonical schema used within the discrepancy detection system 122 for optimized storage, retrieval, and analysis.

At block 708, the mapped payment data rows are matched to existing mortgage contracts by a Payments Matcher subsystem (“matcher”.) The Matcher utilizes blocking algorithms and identifiers like Assessor's Parcel Number (APN) to match each payment to the corresponding contract in the Contracts table 302. Blocking groups payments and contracts into blocks based on APN is to limit the search space when matching. This improves matching performance at scale. Within each APN block, the Matcher executes similarity functions to compare payment and contract identifiers. Candidates exceeding a match score threshold are considered matched. Other identifiers that can be used in the matching process include:
Borrower Name
Property Address
Mortgage Account Number

These identifiers are compared using string similarity metrics like Levenshtein Distance and Jaro-Winkler Distance.

The Matcher handles scenarios like typos, abbreviations, and nicknames through fuzzy matching. A NoMatch table (not shown) stores payments that could not be matched to any contract after exceeding predefined match attempts.

At block 710, successfully matched payment-contract pairs result in the payment getting appended to the payments array field of the matched Contract document in the database 126. This links each discrete payment to the corresponding mortgage contract to give a complete history that supports discrepancy detection.

At block 712, a change detector subsystem (“detector”) compares the new payment data to recent payment history to identify discrepancies. The detector looks at the last N payments for each contract, where Nis configurable but defaults to 6 based on typical monthly mortgage schedules. The new payment is compared to these N stored payments to check for differences in key fields such as for example:
Payment Amount
Payee Name
Payee Account Number
Payee Routing Number

To enable comparison of sensitive fields, the detector decrypts the new and stored payment details in memory during the discrepancy check.

Any difference detected across the comparisons triggers the contract to be flagged as a Potential Lead, indicating a higher likelihood of a mortgage violation. Specifically, the status field of the contract document in the contracts table 302 is updated to “Potential” and the tier level is set based on the payment change detected. For example, a change in payee name would be a Tier 1, while a change in amount could be Tier 2. The original encrypted payment details are appended to the payments array of the contract document before re-encrypting the sensitive fields. This provides an immutable history of payments, including the specific change that triggered the violation flagging, for later review and investigation. By detecting granular payment changes, the detection system 122 can identify potential mortgage violations earlier and with more precision than public records alone.

Finally, at block 714, the notification subsystem 212 generates alerts to summarize the payment data upload and any contracts flagged for discrepancies. The notification subsystem 212 implements a rules engine that determines which users should be notified based on their roles and the teams they belong to. For a payment data upload, admins in the organization may receive a summary email and in-app notification indicating:
Number of payment records uploaded
Number of valid vs. invalid rows
Number of rows successfully matched to contracts
Number of unmatched rows needing review

For any contracts flagged as “Potential Leads” due to a payment discrepancy, the assigned investigator and team admins may receive detailed alerts including:
Contract identifier
Type of payment change detected (amount, payee, etc.)
Severity tier of violation flagging
Link to inspect and assign the investigation

These notifications keep users apprised of payment data ingestion activity and allow rapid follow-up on any high-priority violation flags. The notifications contain summaries—sensitive payment details are not included. This maintains security while providing actionable insights.

The notification subsystem 212 enables timely awareness and response to both system operations and mortgage discrepancies.

By ingesting granular payment data alongside contracts and cross-referencing for changes, violations can potentially be detected earlier than via public records alone. Sensitive data is protected throughout.

### Access and Processing of Public Data

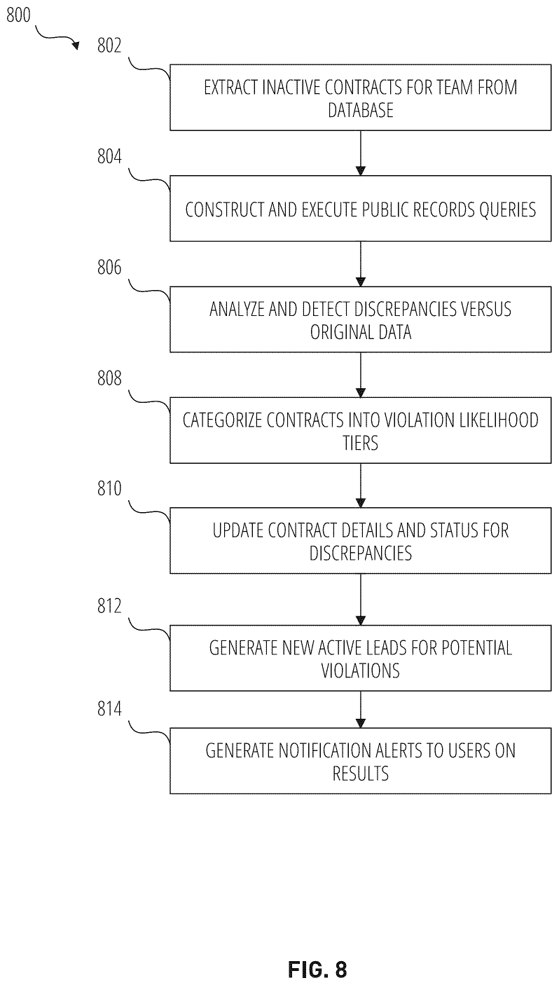

FIG. 8 which is a flowchart illustrating a method 800 of accessing public data relating to the contracts, as may be performed by the public records querying subsystem 206 and discrepancy analysis subsystem 208 at block 412 of the method 404 described in FIG. 4.

At block 802, the public records querying subsystem 206 queries the contracts table 302 in the database 126 to identify records for mortgage contracts with status ‘inactive’ for a specified user team, using the provided TeamID to filter. The public records querying subsystem 206 streams the filtered inactive contracts containing the original client data to the next processing stage.

At block 804, the public records querying subsystem 206 constructs API queries to the third-party application 114 with access to the public data sources 130 for each inactive contract, using identifying fields like APN, property address, and owner name for example. The public records querying subsystem 206 uses failover logic to try secondary public data sources if the primary query fails, and logs permanently unavailable records for that contract based on repeated failures.

At block 806, the discrepancy analysis subsystem 208 implements field-by-field comparative logic to identify discrepancies between each contract's original data as reflected in a corresponding record in the contracts table 302 and the corresponding public records data queried by the public records querying subsystem 206. Any fields with differences are flagged by the discrepancy analysis subsystem 208 and stored in the discrepancies table 306.

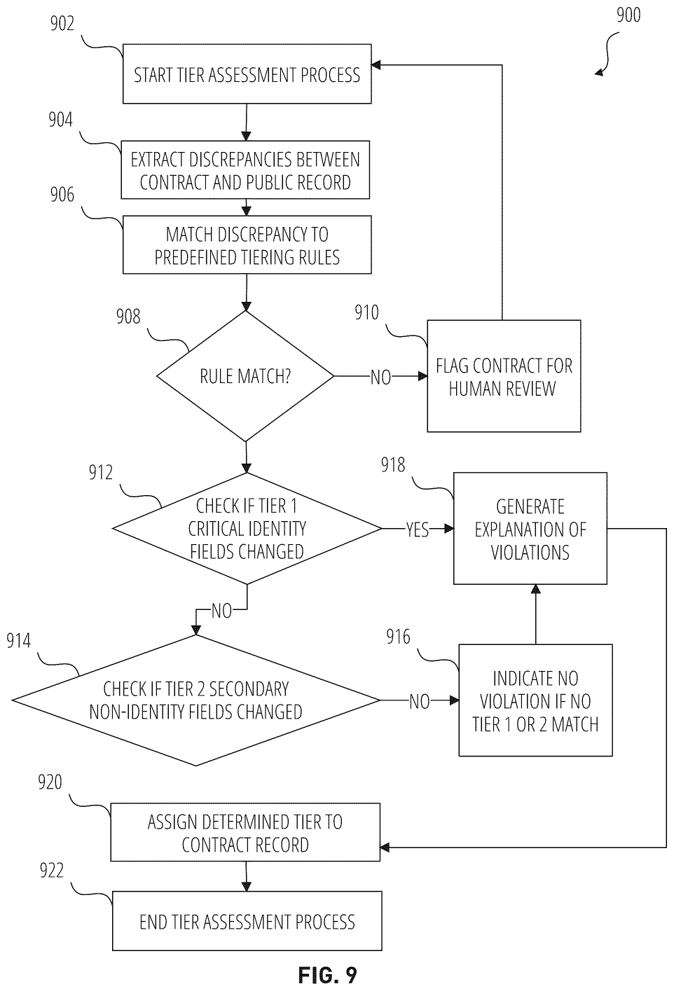

At block 808, a tier classifier module of the discrepancy analysis subsystem 208 categorizes each contract record (e.g., into Tier 1, 2, or 3) based on the discrepancies found, following predefined tiering system rules encoded in the classifier logic. This indicates the severity and likelihood of a mortgage violation. Further details of this categorization process, according to some examples, is described below with reference to FIG. 9.

The tiering methodology deployed by the discrepancy analysis subsystem 208 may use a predefined set of rules encoded as a rules engine that maps certain discrepancy triggers to specific tiers. For example, a difference in owner name may be a Tier 1 while a change in assessed value is Tier 2. Combinations of triggers also factor in. The rules engine may encode certain domain expertise gained from experience with common indicators of violations and based on historical data analytics. Some examples of method 900 of tier categorization are discussed below with reference to FIG. 9.

At block 810, a Contract Updater module recalculates time elapsed, interest/principal remaining, and potential refinance targets for contracts with discrepancies. The Contract Updater module updates the Contract Status to ‘potential’ and appends the discrepancy details.

At block 812, an Active Leads Generator module creates a new active lead record in the active leads table 324 for contracts marked as potential violations and saves them linked to the original contracts in the database 126. This pulls the relevant contracts out of the inactive pool.

At block 814, the notification subsystem 212 sends alerts about the public records query results, including summary statistics and details on new potential leads to users based on their roles and teams.

### Self-Storage of Data as a Secondary Source

Whether through changes in the public or client data, it may occur that information for a specific contract in the contracts table 302 is no longer able to successfully find a match when querying the public data sources 130. Without a fallback procedure, the information that the public records querying subsystem 206 could present to the user may be limited to fields used to query the public records no longer match. The public records querying subsystem 206 would thus be unable to definitively say if the discrepancies stem from errors introduced by the client or from legitimate changes to the public record.

To address this, contracts that are queried against public records in the public data sources 130 for the first time by the public records querying subsystem 206 save that public data in the database 126. The database 126 may be implemented using PostgreSQL for relational structure and the ability to efficiently query any data field. The public data will be stored in a JSON document format to accommodate varied and dynamic API response structures.

Two main database tables are utilized-the contracts table 302 for client mortgage contract data, and a public records table 304 for public record data. The public records table 304 has an identifier field that matches the primary key of the associated contract record in the contracts table 302. This allows linking each contract to its corresponding public data through a foreign key relationship.

Additional fields in the public records table 304 include timestamp, source API,

request parameters, and response body containing the full public record document. The body is indexed for efficient text search.

When an initial public records query is performed by the public records querying subsystem 206, the API response is normalized and inserted into the public records table 304 linked to the contract record in the contracts table 302.

If a subsequent query fails because the client's data in the contracts table 302 no longer matches the public API's request parameters, the historical public data in the public records table 304 provides a fallback that can be queried by any available field. As long as one field remains unchanged in the client data in the contracts table 302, it can be used to retrieve the linked public data record in the public records table 304 and perform field-by-field comparisons. This allows the discrepancy analysis subsystem 208 to definitively identify if changes occurred in the client data, public data, or both.

To optimize storage and performance, partitions aligned by date range are used in both the contracts table 302 and public records table 304. Older historical public data will be archived in a separate time-series database. Frequently accessed fields will be cached in Redis for low-latency reads.

By retaining public data records linked to contracts in the public records table 304, the detection system 122 maintains a secondary data source to keep contracts queryable despite changes in primary records. This provides a robust fallback option that improves monitoring continuity.

### Tier Classification

FIG. 9 illustrates a flow chart of a method 900 performed, at block 808 of FIG. 8, by the tier classifier module of the discrepancy analysis subsystem 208 to categorize contracts into severity tiers based on identified discrepancies.

The tiering methodology deployed by the discrepancy analysis subsystem 208 may use a predefined set of rules encoded as a rules engine (of the tier classifier module) that maps certain discrepancy triggers to specific tiers. For example, a difference in owner name may be a Tier 1 while a change in assessed value is Tier 2. Combinations of triggers also factor in. The rules engine may encode certain domain expertise gained from experience with common indicators of violations and based on historical data analytics. The rules engine may match triggers identified for a given contract against the trigger profiles for each tier.

Some example factors that determine tiering:
The number of discrepancies
The fields involved-identity fields flag higher
Whether the triggers align with clear violation scenarios

At block 902, the discrepancy analysis subsystem 208 starts the tier assessment process when a contract record is received by the subsystem.

At block 904, the discrepancy analysis subsystem 208 extracts any discrepancies between the contract data fields (e.g., of the contracts table 302) and associated public records data (e.g., data from the public data sources 130. Discrepancy identification utilizes methods such as field matching, value comparison, and change detection.

At decision block 906, the extracted discrepancies for the record are matched by the discrepancy analysis subsystem 208 against a set of predefined tiering rules that map specific triggers and combinations to tiers. The rules may be encoded in a tier classifier module of the discrepancy analysis subsystem 208. If a match is found, at decision block 908, the discrepancy analysis subsystem 208 determines the appropriate tier. Otherwise, the contract record is flagged the contract for human review at block 910.

At decision block 912, the discrepancy analysis subsystem 208 checks if a first set of predetermined fields (e.g., identity fields) were modified, indicating Tier 1. Tier 1 represents a likely unauthorized transfer of ownership not disclosed to the lender, as may be needed by mortgage terms. If Tier 1, the discrepancy analysis subsystem 208 generates an explanation describing the violations at block 918.

At decision block 914, the discrepancy analysis subsystem 208 checks for changes to a second set of predetermined fields (e.g., secondary non-identity fields), representing Tier 2. Tier 2 may mean further monitoring is required in case a violation is forthcoming. If yes, block 918 generates the explanation.

At a high level, example tiers may include:
Tier 1—Identity fields like owner name or property address changed, indicating a likely unauthorized transfer of ownership or title not disclosed to the lender as required by the mortgage terms—e.g., included in a refinance/renegotiation interface 1202.
Tier 2—Secondary non-identity fields changed, warranting further monitoring in case a violation is forthcoming when other records update—e.g., to be included in 1202. More specifically, in the event that only Tier 2 identifiers have been triggered, it may indicate that the public records do not currently reflect a violation. Users may want to monitor these situations because a violation may be forthcoming. For example, records could be updated at one public office and not yet others. It could also be the case that the lender's mortgage data contains an error. The discrepancy analysis subsystem 208 may present the likelihood of which situation is taking place, based on the number and category of Tier 2 triggers present.
Tier 3—Tertiary changes made by external parties that alone do not indicate a violation—e.g., to be included in a refinance/renegotiation interface 1202. Such triggers could be the result of an error in the mortgage data, a change initiated by the custodians of the public records, or a change in the condition of the economic environment. Again, the discrepancy analysis subsystem 208 may indicate the likely scenario, and the user can decide if the information is actionable.

For example:
A change in OwnerlFullName in the contracts table 302 may be categorized as Tier 1 since it clearly signals an unauthorized change of ownership not reported to the lender.
A modification of both ParcelNumber in the contracts table 302 and Zoning in the public data sources 130 may be rated as Tier 1 since these dual identity fields indicate a likely title transfer violation.
A change in LastSaleRecordingDocumentId in the contracts table 302 may be categorized as Tier 1 as it indicates a more recent sale of the property has occurred without lender authorization.
A change in one of the property-use TaxEmemption statuses in the contracts table 302 may be categorized as Tier 1 since a significant deviation in the purpose of the property indicates that a sale is likely to have occurred without notice to the lender. Property-use exemptions include those for libraries, schools, cemeteries, hospitals, public utilities, or religious institutions.
A change in ClosePrice in the contracts table 302 may be categorized as Tier 1 as it demonstrates a sale of the property has occurred without lender consent.
A change in AssessedValue in the contracts table 302 alone may be Tier 2 as external factors like market shifts could be responsible and further monitoring is required.
A change in the YearBuiltEffective in the contracts table 302 is Tier 2. While the new construction may have been done by the original owner, the property may also have been sold and modified. In such a case, the authorizing department for the modification could have updated their public records at the onset of construction, before the deed of sale was recorded. Thus, further monitoring is warranted.
A change in the LotSizeAcres in the contracts table 302 would be Tier 2 since a reduction in the size of the property may or may not indicate a portion of the property was sold. Further monitoring is necessary to determine whether or not the reduction in size was a fault of the borrower.
A change in an owner-related TaxEmption status in the contracts table 302 would be categorized as Tier 2. While a new owner from an unauthorized transfer can be filing for the updated exemption, it could also be the case that changes in the original borrower's life circumstances qualified them for the new status. Owner-related exemptions include veteran, disabled, widowed, senior, or welfare.

If no Tier 1 or 2 match occurs, the discrepancy analysis subsystem 208, at block 916, indicates no current evidence of a violation.

Explanations are generated for all tier outcomes by the discrepancy analysis subsystem 208 at block 918 Beyond just identifying the tier, the discrepancy analysis subsystem 208 also generates a descriptive explanation for the user detailing the specific triggers present and reasoning for the assigned tier, to provide full context. A tier value is appended to each contract record in addition to the discrepancy details. This allows convenient filtering and prioritization of contracts that likely need further investigation vs routine monitoring. By classifying severity in a standardized way, the tiering system allows contracts to be triaged effectively based on objective factors determined through rigorous analysis of regulatory scenarios. The tier rules are calibrated over time based on outcomes to ensure the tiers accurately correlate with violation probability.

At block 920, the discrepancy analysis subsystem 208 assigns the determined tier to the contract record before block 922 ends the assessment. The standardized tiers allow effective triage and prioritization of contracts for investigation.

### Automated Managing of Leads

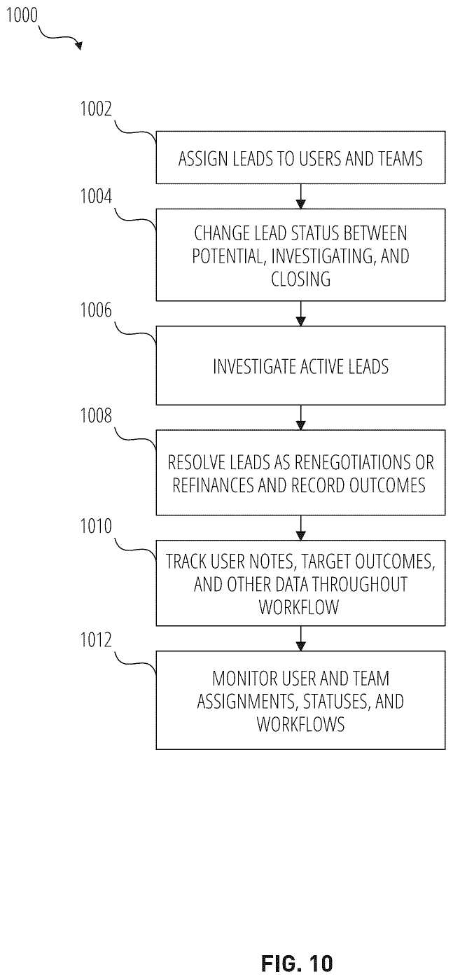

FIG. 10 illustrates a method 1000, according to some examples, that may be performed by the workflow subsystem 210 to facilitate the managing of leads generated from discrepancies using workflows (e.g., corresponding to block 414 of FIG. 4). This includes functions like assigning, investigating, and resolving leads by interacting with tables like the active leads table 324, the users table 312, and the teams table 314. Final outcomes are recorded for closed leads in the closure table 322. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence. The method 1000 also references interfaces described below with reference to FIG. 12-FIG. 16B.

At block 1002, the workflow subsystem 210 handles lead assignment as follows: When new leads are identified by the discrepancy analysis subsystem 208, they are inserted into the active leads table 324 with a status of “potential” and the assigneeIds array empty. A scheduling algorithm built into the workflow subsystem 210 codebase periodically checks the active leads table 324 for new potential leads with empty assigneeIds.

For each new potential lead:
The scheduling algorithm queries the teams table 314 to find the teamId associated with the lead based on the belongsToTeam foreign key.
The scheduling algorithm then queries the users table 312 to find userId values for users 128 belonging to that teamId.
Next it applies a round-robin assignment algorithm to select one of the team's users 128 that has the lowest number of currently assigned leads, based on counting the number of leads with that userId in the assigneeIds array.
The selected user's userId is appended to the assigneeIds array for that lead in the active leads table 324 via an UPDATE statement.
Additionally, the dateInvestigating field is set to the current timestamp to move the lead status to “investigating”.

Notifications are triggered using the notification subsystem 212 to inform the assigned user 128 and team admins of the new assignment.

By periodically running this algorithm, new potential leads are efficiently assigned to team members (e.g., users 128) with balanced workloads. The scheduling algorithm aims to distribute leads evenly based on team member capacity. Other assignment strategies like round-robin, random, or priority-based could also be implemented.

At block 1004, the workflow subsystem 210 changes the status of leads between defined values as they progress through an investigation workflow. This is accomplished by updating the status field in the lead record stored in the active leads table 324.

The active leads table 324 may be implemented as a PostgreSQL database table that contains a status field with a VARCHAR data type to store the current status value for each lead. The allowed values for status are:
‘potential’—Indicates the lead was identified as having discrepancies between the mortgage data and public records and warrants investigation. This is the initial status when a lead is inserted.
‘investigating’—Indicates a user has been assigned and is actively investigating the lead to determine if a violation occurred.
‘closing’—Indicates the investigating user has made a determination and is initiating closure activities like gathering details on the resolution.
‘closed’—Indicates the lead has been fully resolved, details recorded, and the lead is no longer active.

The workflow subsystem 210 provides APIs and endpoints for other components to update status values when certain events occur:
The scheduling algorithm updates status to ‘investigating’ when assigning a user to a new lead.
The user interface subsystem 202 allows assigned users to update status to ‘closing’ when ready to resolve a lead.
The workflow subsystem 210 updates status to ‘closed’ once all closure details are entered.
Admins can update status values back to ‘potential’ to reopen leads if needed.

At block 1006, assigned users 128 investigate active leads in detail through the user interface 202, which queries lead records from the active leads table 324.

When a user 128 is assigned to a new lead by the workflow subsystem 210, they are granted access to view and edit the lead's record in the active leads table 324 of the database 126. A refinance/renegotiation interface 1202 provides a dashboard page that displays a list of the user's assigned leads, including key details like status, mortgage identifier, property address, etc. Selecting a lead loads a detailed investigation page. The refinance/renegotiation interface 1202 executes a SQL query against the database 126 to retrieve the full record for that lead ID from the active leads table 324.

The investigation page displays the following data for the lead:
Discrepancies identified by the discrepancy analysis subsystem 208, including the fields affected and their original vs. current values.
Mortgage details like the original principal, interest rate, term, etc.
Property details like address, ownership history, valuations, etc.
A log of all previous investigation notes entered by users 128.
Target details like the projected interest rate and profitability for a refinance.

Additionally, the investigation page provides forms and interfaces for the user 128 to:
Add new investigation notes to log their findings and analysis, which are appended to the notes JSON array field in the active leads table 324 record.
Attach files like documents and images related to the investigation. The files may be uploaded to an S3 bucket and the links stored in the attachments JSON array field.
Edit any details about the lead, mortgage, or property by submitting changes that execute UPDATE queries against the active leads table 324.
Change the target outcome between renegotiation and refinance, which updates the targetOutcome field.
Adjust the target interest rate, term, and other refinance projections by updating related fields.
Reassign the lead to a teammate by altering the assigneeIds array field.
Change the status of the lead, for example to ‘closing’ once the investigation is complete.

By providing a detailed view and editing ability, the refinance/renegotiation interfaces 1202 allow assigned users 128 to thoroughly investigate leads by leveraging the centralized data in the active leads table 324. Users can log their findings, update details, and change outcomes over the course of the investigation.

At block 1008, users 128 resolve leads as either renegotiations or refinances of the original mortgage agreement. The final outcomes and details are recorded in the closure table 322.

Once a user 128 completes investigating a lead and determines the appropriate resolution, they change the status to ‘closing’ through the user interface 202. This triggers the workflow subsystem 210 to create a pending closure record in the closure table 322 database table.

The closure table 322 may be implemented in PostgreSQL and contain columns for data such as:
The lead ID of the associated active lead.
Resolution type—‘renegotiation’ or ‘refinance’.
New interest rate if a refinance occurred.
New monthly payment amount.
Total profit earned by the lender.
Resolution notes entered by the user.

A refinance/renegotiation interface 1202 displays forms for the user 128 to enter closure details. Required fields may include selecting the resolution type and entering the newly agreed-upon terms. For a renegotiation, the user 128 enters notes on the investigation findings and agreed updates. For a refinance, the new mortgage terms are entered such as rate, principal, and duration.

Once required closure data is entered, the refinance/renegotiation interface 1202 submits it to the workflow subsystem 210 API. Software logic implemented in Golang may validate the data and insert a finalized closure record into the closure table 322, marking the pending record as resolved.

The workflow subsystem 210 also updates the status of the lead to ‘closed’ in the active leads table 324 and removes the lead record now that resolution is complete.

By storing closure details like the resolution type, new terms, and profitability gained in the closure table 322, the detection system 122 maintains a historical record of resolved leads for reporting and auditing purposes. The closure table 322 can be queried to generate aggregate statistics on renegotiations vs. refinances, profitability over time, and other insights.

At block 1010, the workflow subsystem 210 tracks various data elements related to the investigation of each lead in the active leads table 324 as they progress through the workflow.

The active leads table 324 may be implemented in PostgreSQL and contain columns to store detailed data on every lead as it is identified, assigned, investigated, and closed out. Some example fields include:
notes—A JSON array field that stores a log of all text notes entered by users 128 during investigation, documenting findings, analysis, and decisions. New note entries are appended to the array.
targetOutcome—A field that indicates if the user's intended resolution is a renegotiation or refinance of the mortgage. Can be updated anytime.
targetInterestRate—The projected interest rate if pursuing a refinance resolution. Can be adjusted by the user.
targetTermMonths—The projected new loan term if pursuing a refinance. Editable.
attachments—A JSON array field that stores links to any files like documents and images uploaded by users 128 related to the investigation.
statusUpdates—A JSON array that stores a timeline of all status changes (potential->investigating->closing->closed) including timestamps and user IDs.
assigneeIds—An array field that stores the user IDs of all users 128 who have been assigned to this lead for investigation.

The workflow subsystem 210 provides APIs and endpoints for the user interface 202 to read and write these fields in the active leads table 324 records as users 128 work through the investigation process.

Storing this detailed data directly in the active leads table 324 database provides the following example benefits:
Investigation notes are logged centrally over time instead of in isolated systems.
Outcomes and projections can be adjusted as the investigation progresses.
A timeline of status changes and assignments is maintained.
No need for separate audit logging or versioning of changes.
Data is accessible from the user interface 202 for users 128 to view and update.

By leveraging the active leads table 324 as the centralized source, the workflow subsystem 210 can provide oversight and tracking as leads are identified, assigned, investigated, and closed out over time.

At block 1012, the workflow subsystem 210 enables monitoring and oversight of user and team assignments, statuses, and workflows by querying data from the active leads table 324.

The active leads table 324 contains columns like:
assigneeIds—An array of user IDs representing everyone assigned to this lead.
status—The current status of the lead (potential, investigating, etc).
statusUpdates—A JSON array tracking every status change.
createdAt—Timestamp when the lead was created.
closedAt—Timestamp when the lead was resolved.

The workflow subsystem 210 provides a monitoring dashboard page in the user interface 202 for team managers and administrators. It executes SQL queries against the active leads table 324 to aggregate data and generate visualizations that enable oversight, such as:
A table of open leads showing assignees, current status, and age.
A timeline chart of status changes for each lead.
Pie charts showing breakdown of leads by current status.
Bar charts displaying leads assigned to each user over time.
Metrics on average days leads spent in each status.
Charts showing bottlenecks where leads stall in certain statuses.
The dashboard can also filter and break down the aggregated data in different ways like by user, status, date ranges, etc.

By leveraging the workflow data tracked in the active leads table 324, the workflow subsystem 210 provides robust monitoring capabilities to help managers optimize the performance of teams and individuals in processing leads. Data is aggregated into visualizations for high-level oversight as well as detailed tracking of each lead.

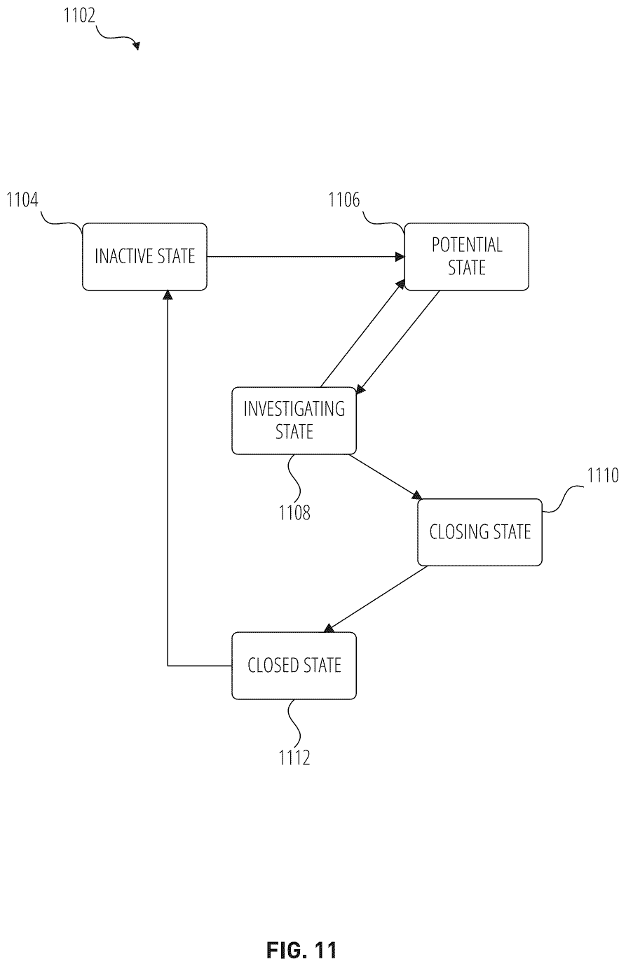

FIG. 11 illustrates an exemplary state diagram depicting state transitions 1102 between status states of a contract, as reflected in a contract record of the contracts table 302, throughout its lifecycle within examples of the detection system 122.

The states may comprise:
An Inactive state 1104, representing the initial state of a contract after upload by a user to the system and when it is in a pool awaiting the next scheduled public records query operation.
A Potential state 1106, transitioned to when a public records query identifies discrepancies between the contract data and public records. The contract is now designated as an active lead requiring further review.
An Investigating state 1108, transitioned to when the contract is assigned to a specific user for detailed investigation. The user evaluates the discrepancies to determine if violations are present.
A Closing state 1110, transitioned to when violations are identified during investigation, and the user initiates a remediation process such as renegotiation or refinance of the contract.
A Closed state 1112, transitioned to when the remediation process completes and a new contract is finalized. Details of the new contract are recorded.

The transitions between states may comprise:
Inactive to Potential: Public records query detects discrepancies, generating a potential lead.
Potential to Investigating: User assigns contract for further review.
Investigating to Potential: Investigation is canceled, returning contract to pool.
Investigating to Closing: User initiates remediation process for violations.
Closing to Closed: New contract finalized after remediation.
Closed to Inactive: Contract details updated and back in monitoring pool.

The state diagram visualizes the workflow and transitions a contract progresses through during its lifecycle within the detection system 122. The discrete states and transitions allow automated tracking, metrics, and status monitoring.

FIG. 12 is a user interface diagram showing user interfaces, according to some examples, generated by the programmatic client 108 or by the web server 120, that allow users to view statistics related to renegotiations or refinances within the detection system 122. These interfaces include an individual team member refinance/renegotiation interface 1202 and a team refinance/renegotiation interface 1204. Each interface includes a navigation section 1206, a refinance vs renegotiation section 1216, a quarterly breakdown section 1208, a statistics summary section 1210, and a main data section 1214.

The navigation section 1206 appears on the left of each interface page and provides a list of menu items that enable a consistent way for users to access the areas and features of a detection system 122 application. The menu items of the navigation section 1206 represent the pages of the application:
Overview—The main dashboard page
   Refinances—Refinance tracking and reporting
   Renegotiations—Renegotiation tracking and reporting
Active Leads—Manage leads workflow
Mortgage Repository—Search and view all mortgages
Team Details
   Member Stats—links to a page displaying performance statistics and metrics for each team member. It shows key indicators like the number of closed refinances, the percentage contribution to team profits, average days between closing events, and more. Charts visualize metrics over time. Admins can view stats for all members while regular users see their own
   Manage Members—This admin-only page allows managing team members. It lists members with name, email, role, status, and joined date. Controls allow admins to add new members by inviting them via email, edit member details, deactivate inactive members, and manage roles/permissions. Changes sync with the user database.

Clicking a menu item in the navigation section 1206 navigates to that page by programmatically updating the browser URL and triggering a route change.

The refinance vs renegotiation section 1216 presents a pie chart visualizing the percentage breakdown of total closed cases between refinances and renegotiations. The pie chart includes two slices—one for the percentage of total cases that were refinances, and another for the percentage that were renegotiations.

Below the pie chart in the refinance vs renegotiation section 1216 are two numerical totals:
Refinances: The total number of refinance cases closed
Renegotiations: The total number of renegotiation cases closed

The refinance vs renegotiation section 1216 thus provides an at-a-glance view of the distribution of outcomes between refinances and renegotiations for closed cases. The percentages visualized in the pie chart give the proportional split, while the totals below give the absolute counts. Together they summarize the resolution outcomes concisely.

The quarterly breakdown section 1208 provides a breakdown of the current quarter, the previous quarter, and the percentage of the goal achieved. For example, the quarterly breakdown section 1208 may be implemented using React components. It shows the total number of refinances closed this quarter, last quarter, and a percentage progress metric versus internal goals set by the team.

Next is a statistics summary section 1210 that may be built using Angular components. This displays the user's key metrics including:
closedRefinancesCount—The total number of refinances closed by this user.
closedRefinancesPercent—Their percent contribution to the total team refinances. Calculated as their count divided by the team total.
grossProfitNumber—The total profit dollar amount earned from their closed refinances.
grossProfitPercent—Their percent contribution to the total team profit.
lastRefinanceDate—A timestamp of when they last closed a refinance.
refinanceFrequency—The average number of days between this user closing refinance events.

The metrics are displayed in a responsive grid built with Bootstrap styling. The dollar amounts and percentages are formatted using NumberPipe and PercentPipe.

Below the statistics summary section 1210 is the main data section 1214 that displays a graph. The x-axis of the graph represents the months within a configurable time range. The y-axis shows numeric dollar values for gross profit. Hovering over or selecting a graph line invokes display of an overlay window with details for the selected month, including:
closedRefinances—The count and percentage of refinances closed each month by the user.
grossProfitNumber—The total and percentage profit dollars earned each month.
grossProfitPercent—The average profit percentage each month.

Hovering over data points displays tooltips with the exact values using d3-tooltip. Buttons allow the toggling display of the lines on/off. A selector allows choosing between a monthly or refinance perspective. Monthly shows aggregated metrics per month. Refinance shows data points for each individual refinance event. The time frame can be changed to display the last year, two years, or a custom date range with a date picker control from ngx-bootstrap, for example.

The team refinance/renegotiation interface 1204 follows a similar structure but displays aggregated metrics across all team members. Individual user contributions are shown as percentages of the team totals.

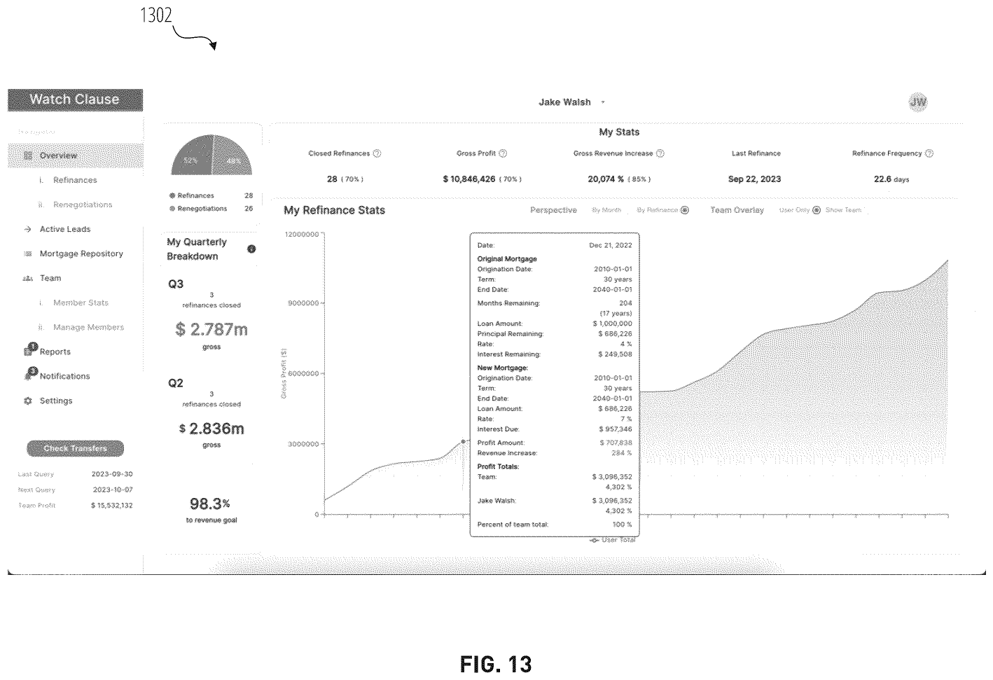

FIG. 13 is a user interface diagram illustrating an individual refinance/renegotiation interface 1302, according to some examples.

The refinance/renegotiation interface 1302 contains a line chart with the x-axis representing the timeline and y-axis showing accumulated gross profit in dollars. Each data point plots a specific refinance event completed by the user. Hovering over a point displays a tooltip with details including for example:
Date: Apr. 27, 2023
Original Mortgage Details:
   Origination Date: 2005 Jan. 1
   Term: 30 years
   End Date: 2035 Jan. 1
   Months Remaining: 140
   Loan Amount: $200,000
   Principal Remaining: $125,286
   Rate: 7%
   Interest Remaining: $57,007
New Mortgage Details:
   Loan Amount: $125,286
   Rate: 7%
   Interest Due: $180,868
   Profit Amount: $123,861
User Total Profit: $3,174,106
Team Total Profit: $3,174,106

Additional functionality includes:
A toggle to overlay the team's total profit on the chart for comparison.
Controls to filter the date range.
Downloadable CSV export of the chart data.

This allows drilling down into the user's individual refinance events over time and analyzing the impact of each event on their overall profits. The team overlay enables assessing their contribution to team totals.

The chart data may be populated by making an API call to the backend (e.g., the detection system 122) to retrieve the user's refinance history, which returns an array of objects containing the date, mortgage details, and profit for each event. This is mapped into the Chart.js data and options configuration. Additional lines for team profit are added as additional datasets. Event handlers are added for the overlay toggle button and date filter input. These call API endpoints to update the chart data and redraw the chart. The CSV export button triggers the underlying Chart.js API method to export the chart data for download by the user.

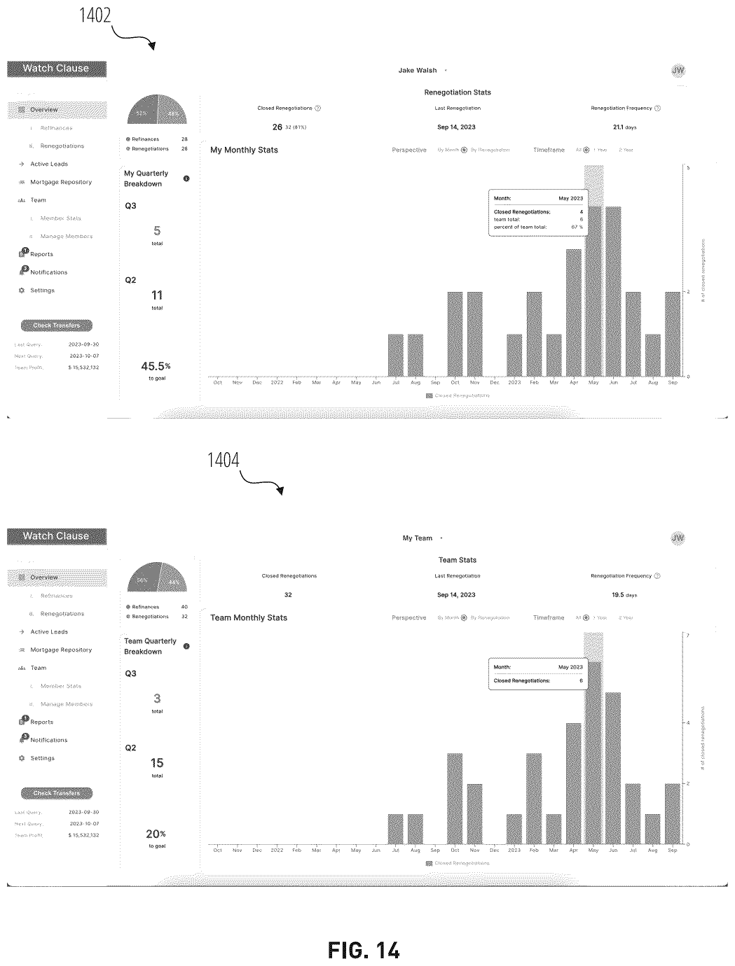

FIG. 14 is an interface diagram illustrating a user refinance/renegotiation interface 1402 and a team refinance/renegotiation interface 1404, according to some examples.

The user refinance/renegotiation interface 1402 shows renegotiation metrics tracked on a monthly basis for an individual user. It contains two sections—a bar chart plotted over time, and a data table.

The bar chart depicts the number of renegotiations closed by the user each month. The x-axis represents the timeline in months, while the y-axis denotes the count of renegotiations. Hovering over a bar shows the specific month and number of renegotiations.

Superimposed on the chart is a data table summarizing the user's renegotiation metrics for a given month. It displays:
Month—The month in review (e.g. November 2022)
Closed Renegotiations—The number of renegotiations closed by the user that month (e.g. 1)
Team Total—The total renegotiations closed across the entire team that month (e.g. 1)
Percent of Team Total-The user's percentage contribution to the team total (e.g. 100%)

This user refinance/renegotiation interface 1402 enables an individual user to track and assess their renegotiation performance on a monthly basis, and measure their contribution to team totals.

The team refinance/renegotiation interface 1404 provides a team-wide view of renegotiation metrics on a monthly basis. It contains the same two sections-a bar chart over time, and a data table.

In this case, the bar chart displays the total number of renegotiations closed by the entire team per month. Hovering shows the month and total count.

The data table summarizes for a given month:
Month—The month in review
Closed Renegotiations—Total renegotiations closed by the team

This team perspective enables managers to track renegotiation performance over time across the group.

The two complementary interfaces provide individual user and team-level visibility into monthly renegotiation metrics.

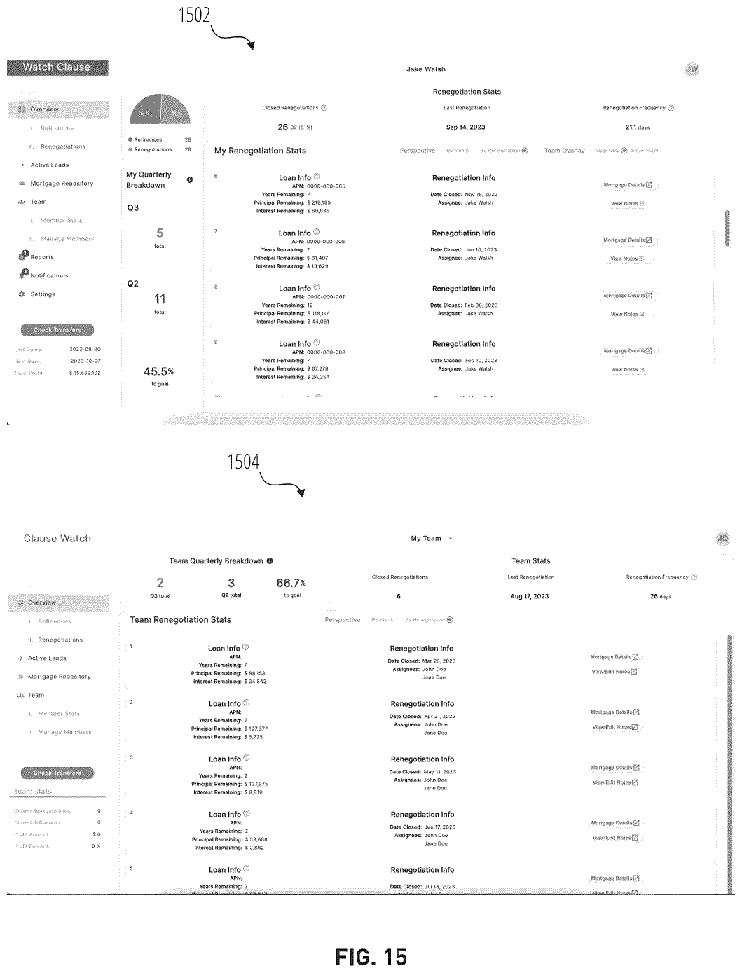

FIG. 15 is an interface diagram illustrating a user refinance/renegotiation interface 1502 and a team refinance/renegotiation interface 1504, according to some examples.

The user refinance/renegotiation interface 1502 and the team refinance/renegotiation interface 1504 each provide a comprehensive view of a specific renegotiation event completed by a user and a team respectively. The interfaces enable comparing the original and renegotiated mortgage side-by-side, along with reviewing investigation notes logged throughout the process.

A quarterly breakdown section shows summarized quarterly statistics for context:
Closed Renegotiations: The number of renegotiations closed this quarter (e.g. 4)
Last Quarter's Total: The number closed last quarter (e.g. 6)
Percent to Goal: The percentage progress through the quarter (e.g. 66.7%)

Below the quarterly breakdown section is a team renegotiation section displaying cards representing individual renegotiation events, with the details contained in expandable sections.

Each card may display:
Loan Information:
   Loan ID: The unique mortgage identifier
   Loan Details: Original mortgage attributes like principal, interest rate, term, etc.
Renegotiation Information:
   Renegotiation Date: The date the renegotiation completed
   Assignees: The users who worked on the renegotiations
Mortgage Details Link: Logs entered by users tracking findings and decisions
Edit Notes Link: Opens the notes editor to add or modify notes

This layout enables drilling down into individual renegotiation events, comparing pre and post details, and reviewing the associated investigation trail.

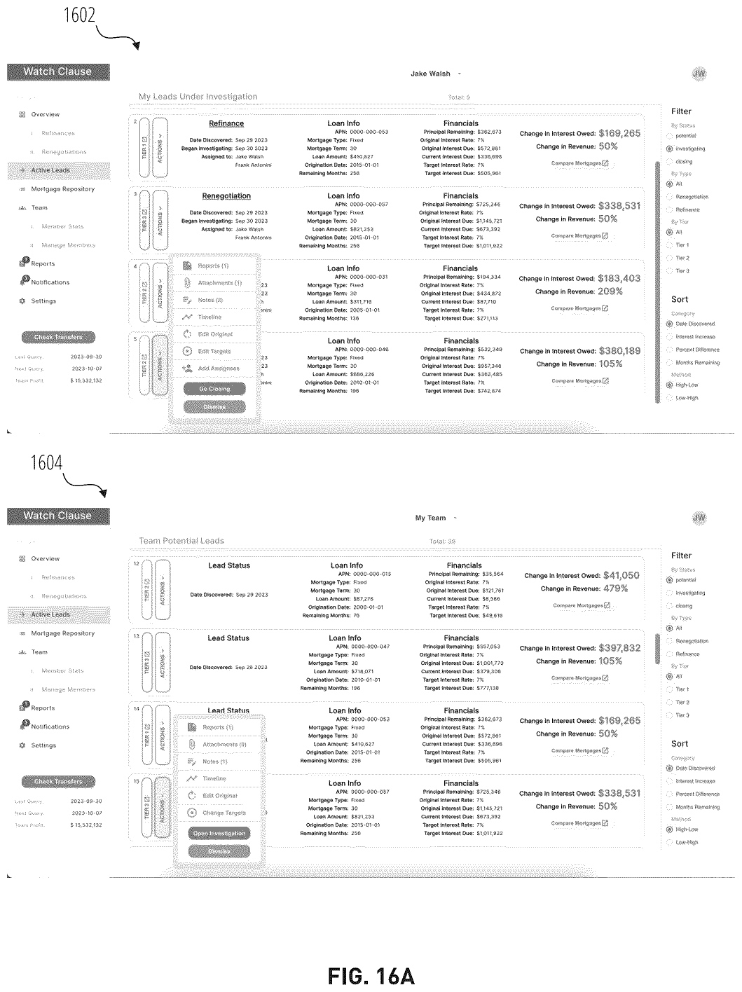

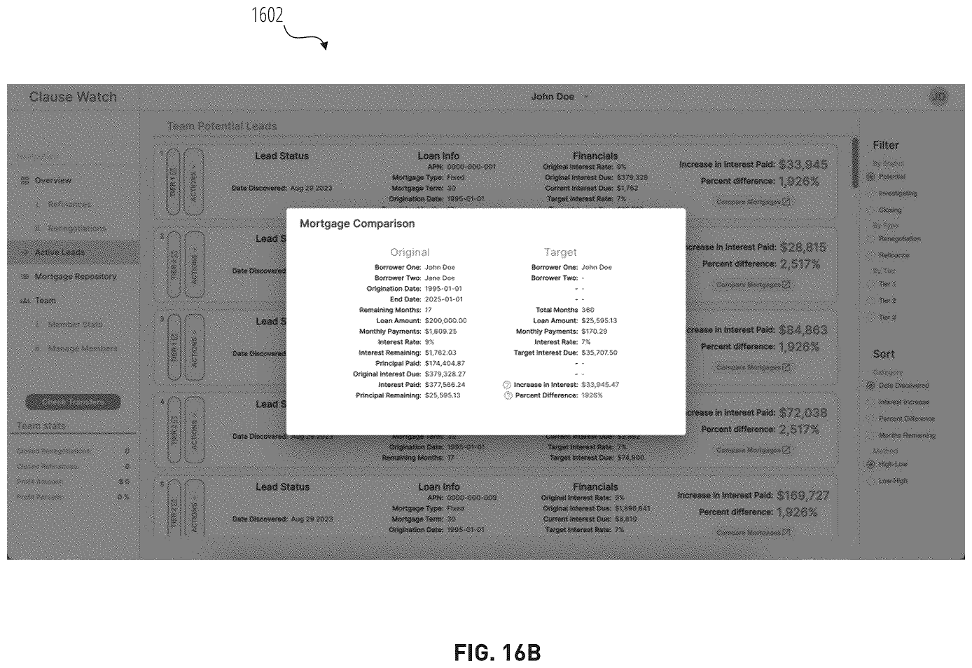

FIG. 16A and FIG. 16B illustrate active leads interfaces, according to some examples, with active lead information selected in the navigation section.

Each of the interfaces presents a filter section on the right that presents filtering and sorting options with respect to leads shown in a main leads section. These options may include:
Filter leads by status, type, severity tier
Sort leads by category, date, potential profit, etc. User can also select a sort direction—high to low or low to high.

Powerful filtering and sorting enables optimized lead prioritization.

A user active leads interface 1602 shows filtered mortgage leads in the initial “investigating” status after discrepancies are detected. Each lead is represented by a respective card displaying key details:
Lead Status—The severity tier (e.g., Tier 1, Tier 2, etc.)
Actions—Buttons to assign, investigate, or dismiss the lead
Refinance/Renegotiation Data
   Date Discovered—When discrepancies were detected
   Began Investigation Date
   Assigned to: user names of users investigating the lead
Loan Information—Mortgage attributes like ID, type, origination date, term, etc.
Financials—Original interest rate, original interest due, current interest due, target interest rate, and target interest due, etc.

This view allows users to triage new potential leads by severity tier and loan details.

The user active leads interface 1606 also shows the actions available on potential leads:
Add/View Notes—Log investigation notes
Edit Original Data—Update incorrect contract data
Change Targets—Adjust proposed refinance terms
Assign/Investigate—Assign lead for investigation
Dismiss—Dismiss invalid lead (e.g., Go Cold)

These actions let users manage leads from the potential status.

A team active leads interface 1604 shows filtered mortgage leads assigned to a team with the status “potential” as they review the discrepancies. This view provides additional context as team members investigate leads.

In FIG. 16B, a user active leads interface 1606 shows a mortgage comparison card that is overlaid on the user active leads interface 1606 responsive to user selection of a lead. This mortgage comparison card enables side-by-side analysis of the original mortgage terms versus the target refinance terms proposed by the system. It contains comparative data for multiple variables of both mortgages, including:
Original Term vs Target Term—The length of the mortgage terms in years.
Original Loan Amount vs Target Loan Amount—The total principal borrowed.
Original Monthly Payments vs Target Monthly Payments—The regular scheduled payment amounts.
Original Interest Rate vs Target Interest Rate—The annual percentage rates.
Original Total Interest vs Target Total Interest—The total interest paid over the full term.
Original Fees vs Target Fees—Upfront fees and closing costs.

The full terms of both mortgages are compared field-by-field. Further, increases in interest and percent differences are also presented.

This overlay pops up responsively when a user selects a lead, allowing them to conveniently analyze the impact of the proposed refinance targets on key mortgage variables. The side-by-side comparisons improve the user's ability to evaluate the refinance recommendations as they investigate leads.

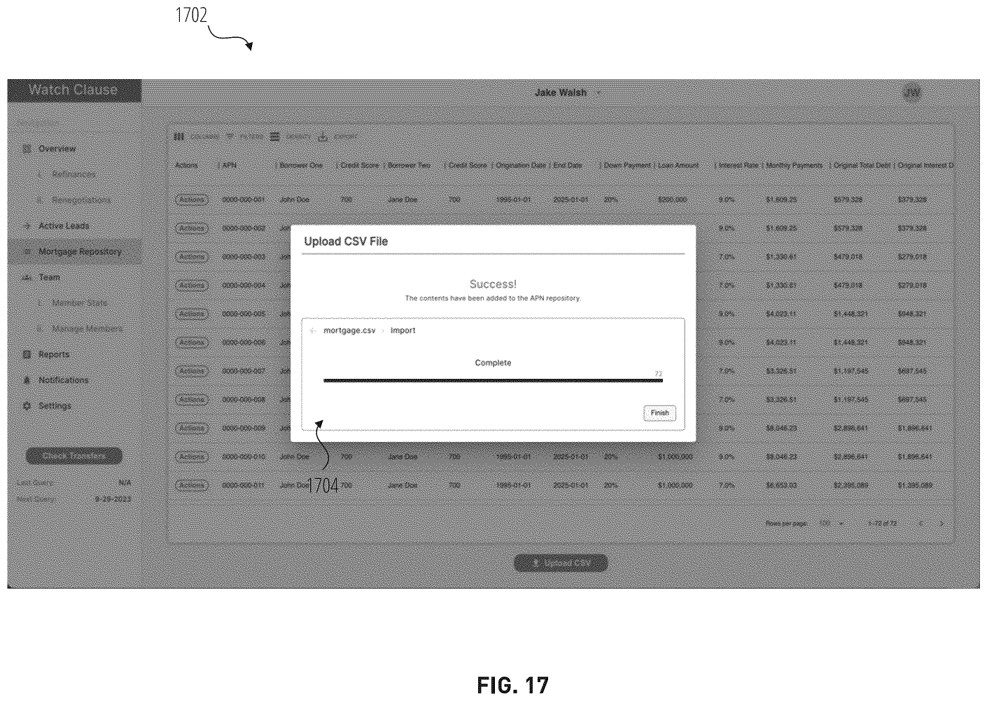

FIG. 17 is a user interface diagram showing a mortgage repository interface 1702, according to some examples, which allows users to view and manage mortgage contracts uploaded to the detection system 122 using the method 700 described above.

The mortgage repository interface 1702 displays a searchable and filterable list of mortgages with key details like address, owner, loan amount, type, status, etc extracted from the contracts table 302. Users can search, filter, sort, and export the mortgage data.

When a user uploads a new CSV file of mortgage contracts via the upload functionality, an overlay upload card 1704 is displayed indicating the upload result. As shown, this upload card 1704 displays a confirmation that the CSV file was successfully parsed and inserted into the repository and contracts table 302.

The card may, in some examples, also shows helpful upload statistics including:
Number of rows processed from the CSV
Number of rows successfully validated and inserted
Number of rows failing validation

These metrics provide feedback on the quality of the uploaded data. For failed rows, alerts are sent to the user with details to correct issues.

By displaying upload confirmations and statistics directly within the mortgage repository interface 1702, users can easily monitor the ingestion of new contract data into the detection system 122.

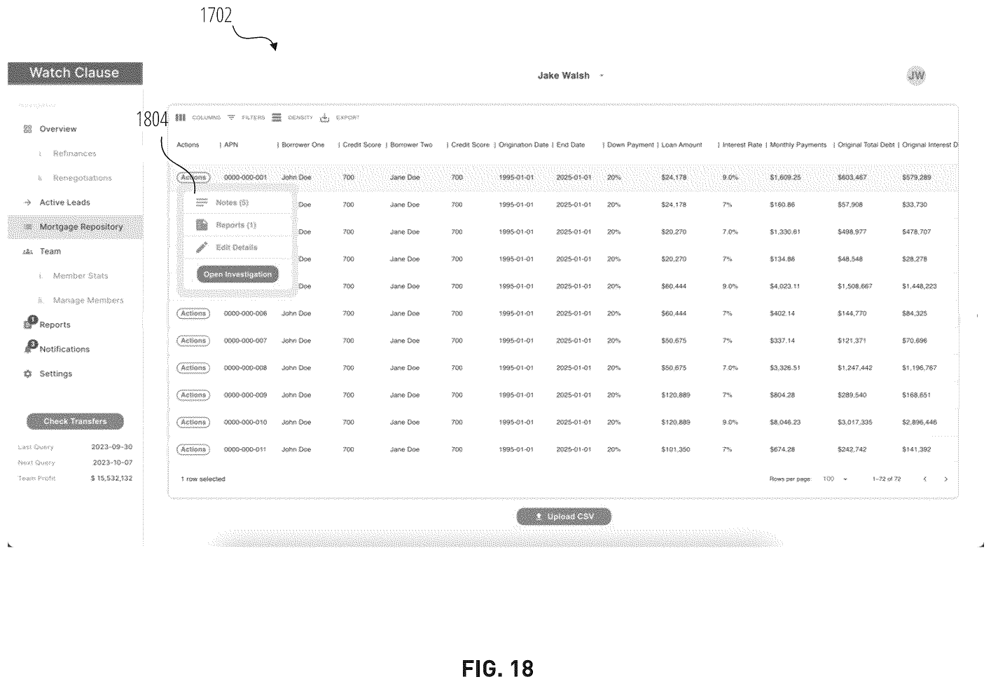

FIG. 18 is a user interface diagram showing a mortgage repository interface 1702, according to some examples, with mortgage actions card 1804 that displayed responsive to user-selection of an action button associated with each row of mortgage data in the mortgage repository interface 1702.

The mortgage actions card 1804 enables users to take direct actions on mortgages without leaving the repository view. The actions available may include:
Open Investigation—Manually open an investigation into potential discrepancies or violations for this mortgage. This assigns the mortgage to the user as an active lead for further review outside the repository.
View/Edit Data—Directly view and edit the mortgage details stored for a contract. A form allows editing stored field values which are then updated in the contracts table 302.
Add Note—Append an investigation note which is logged and displayed in the active lead user active leads interface 1602 or team active leads interface 1604 if opened. This may be useful for tracking initial observations.
Change Monitoring Status—Update the monitoring status which controls if the contract is included in public record discrepancy checks. A user can for example pause monitoring temporarily.
Generate Report—Generate a detailed report on this specific mortgage, including its full history, investigation notes, discrepancies found, and resolution details if applicable.

The addition of the “Generate Report” action enables on-demand reporting on a single mortgage directly from the repository view presented by the mortgage repository interface 1702. This creates a quick way to pull up a mortgage's full profile without running broader reports.

As before, these actions overlay the mortgage repository interface 1702, thus allowing rapid investigation and data tasks without disrupting the user's workflow. The mortgage actions card 1804 provides easy access to selected mortgage functionality.

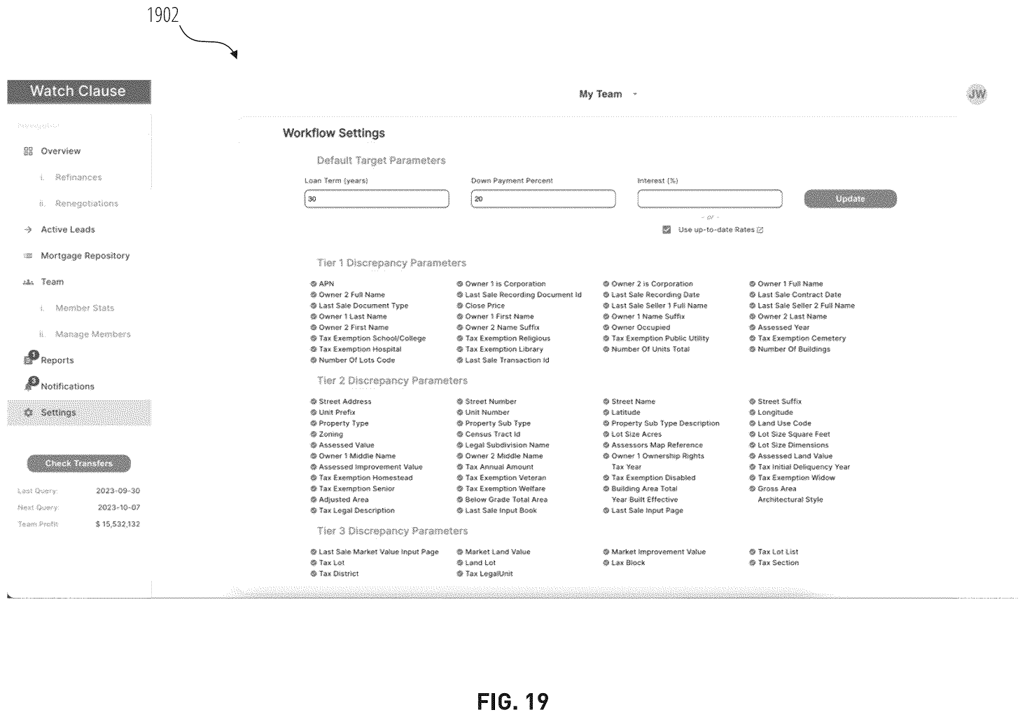

FIG. 19 is a user interface diagram showing a settings interface 1902, according to some examples, that enables users to configure various parameters that control the functionality of the detection system 122

A Target Parameters section allows setting default values that will be automatically applied to new leads when first detected. These may include:
Target Interest Rate—The projected rate used to calculate potential refinance terms. These can be entered manually or integrated with a 3rd party API to look at regional average rates based on property details.
Target Term—The projected loan duration in years for the potential refinance.
Target Down Payment—The projected down payment percentage.

Together these set expected refinance targets for the initial assessment of new leads. Users can adjust them later during an investigation.

The Discrepancy Parameters section in FIG. 19 allows administrators to configure which data fields are analyzed for discrepancies during public records checks. Each field can be toggled on or off for inclusion in the checks.

Additionally, the default severity tier mapping for certain triggers can be customized. The detection system 122 assigns a default tier (e.g., Tier 1, 2, or 3) to certain discrepancy triggers based on rules encoded in the tier classifier module. However, the settings interface 1902 allows overriding these default mappings. For example, a change in the AssessedValue field may be assigned Tier 2 by default, indicating it warrants further monitoring but does not definitively indicate a violation. Using the interface, an administrator could elevate AssessedValue changes to Tier 1. This means any mortgage with a discrepancy in that field will now be categorized as a high-severity violation requiring urgent investigation. The settings interface 1902 allows individually selecting any field and changing its assigned tier. Dropdowns, checkboxes, and other controls facilitate this override capability.

By tuning the tier mappings, clients can customize the severity classification to align with their specific portfolio risk profile. For instance, they could elevate fields related to property value changes to flag those scenarios faster. The tier customization provides flexibility to adapt the violation categorization to each client's needs. The overrides allow calibrating the tiering methodology based on real-world outcomes and domain expertise, for example.

Other settings include:
Notification Settings—Configure notification rules and alerts for different events and user roles.
Workflow Settings—Set workflow timelines, timeouts, and triggers.
Report Settings—Enable/disable certain reports and charts.
Monitoring Settings—Set public records check frequency and API usage limits.
User Management—Add/edit/deactivate user accounts and roles.
Team Settings—Configure team details like name, members, and permissions.

The advanced settings interface 1902 provides control over multiple parameters, notifications, workflows, reports, and more. Customization enables adapting the detection system 122 to each client's specific needs and optimization for their portfolios.

### Machine-Learning Pipeline 2100

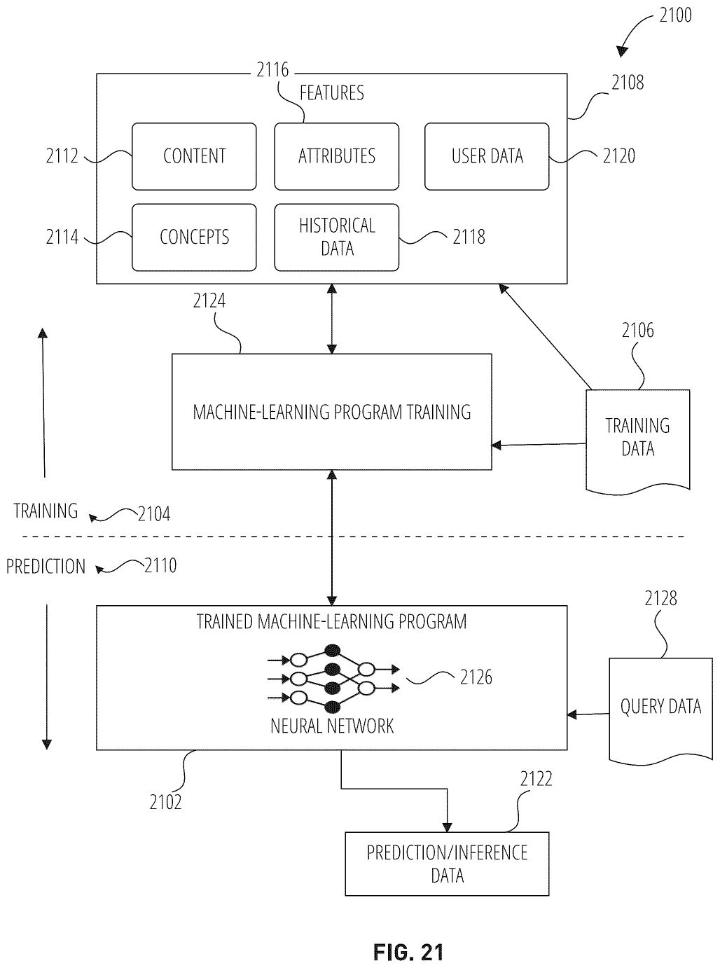

FIG. 21 is a flowchart depicting a machine-learning pipeline 2100, according to some examples. The machine-learning pipeline 2100 may be used to generate a trained model, for example the trained machine-learning program 2102 of FIG. 21, to perform operations associated with searches and query responses. The trained machine-learning program 2102 forms part of the AI/ML subsystem 218.

### Overview

Broadly, machine learning may involve using computer algorithms to automatically learn patterns and relationships in data, potentially without the need for explicit programming. Machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

### Training Phases 2104

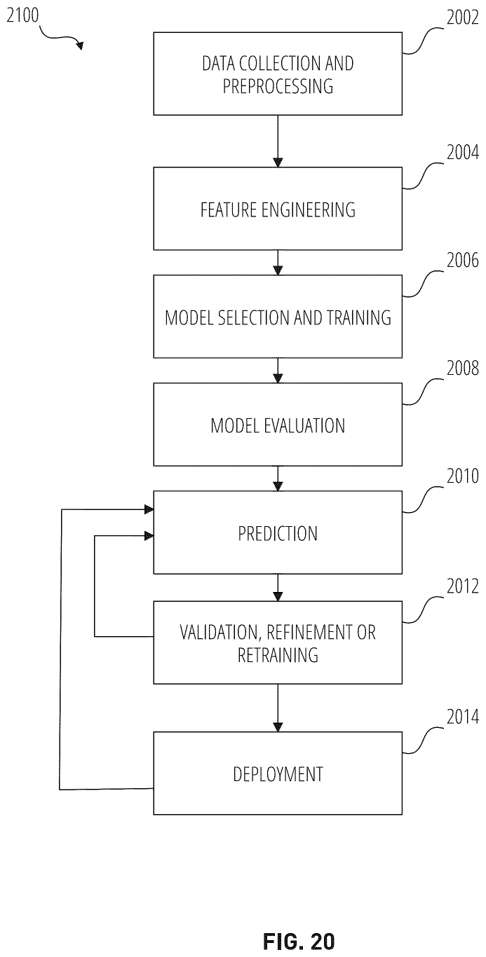

Generating a trained machine-learning program 2102 may include multiple phases that form part of the machine-learning pipeline 2100, including, for example the following phases illustrated in FIG. 20:
Data collection and preprocessing 2002: This phase may include acquiring and cleaning data to ensure that it is suitable for use in the machine learning model. This phase may also include removing duplicates, handling missing values, and converting data into a suitable format.
Feature engineering 2004: This phase may include selecting and transforming the training data 2106 to create features that are useful for predicting the target variable. Feature engineering may include (1) receiving features 2108 (e.g., as structured or labeled data in supervised learning) and/or (2) identifying features 2108 (e.g., unstructured or unlabeled data for unsupervised learning) in training data 2106.
Model selection and training 2006: This phase may include selecting an appropriate machine learning algorithm and training it on the preprocessed data. This phase may further involve splitting the data into training and testing sets, using cross-validation to evaluate the model, and tuning hyperparameters to improve performance.
Model evaluation 2008: This phase may include evaluating the performance of a trained model (e.g., the trained machine-learning program 2102) on a separate testing dataset. This phase can help determine if the model is overfitting or underfitting and determine whether the model is suitable for deployment.
Prediction 2010: This phase involves using a trained model (e.g., trained machine-learning program 2102) to generate predictions on new, unseen data.
Validation, refinement or retraining 2012: This phase may include updating a model based on feedback generated from the prediction phase, such as new data or user feedback.
Deployment 2014: This phase may include integrating the trained model (e.g., the trained machine-learning program 2102) into a more extensive system or application, such as a web service, mobile app, or IoT device. This phase can involve setting up APIs, building a user interface, and ensuring that the model is scalable and can handle large volumes of data.

According to some examples, to deliver accurate AI-enhanced mortgage discrepancy detection, the AI/ML subsystem 218 may leverage the full machine learning pipeline from data collection through to deployment.

First, the AI/ML subsystem 218 may gather and clean training data from the database 126 (e.g., mortgage and payment data repositories), preparing high-quality datasets. For example, to begin model training, the AI/ML subsystem 218 may collect and prepare high-quality training datasets. The AI/ML subsystem 218 queries the mortgage data repository and payment data repository maintained in the database 126 to extract relevant records.

Various data cleaning and preprocessing techniques are applied to ensure data integrity and consistency. For example, duplicate records are identified via primary key checks and removed. Missing values are imputed using statistical methods like mean/median imputation of column values. Categorical variables are standardized by mapping invalid values to a standard schema. Text data is normalized by removing punctuation, case folding, and stemming.

With cleaned data, the AI/ML subsystem 218 applies feature engineering to derive useful inputs for the machine learning models. For predicting mortgage violation likelihood, features may be engineered from fields like owner names, property addresses, loan amounts, interest rates. Identifier fields are converted into Boolean violation indicators. Timeseries payment amounts are aggregated into statistics like mean, variance, trends. Domain expertise guides the feature engineering process.

For optimizing public record queries by the public records querying subsystem 206, features are constructed from past query performance data like APIs called, query response times, result set sizes. Query strings are tokenized and vectorized. Response times are normalized by record count. Aggregate statistics are calculated across query executions.

Additional feature engineering creates model inputs for predicting optimal mortgage refinancing windows, detecting anomalous payment patterns, forecasting public record changes, and more. Advanced techniques like principal component analysis may be used to reduce dimensionality. Domain knowledge ensures relevant predictive features are crafted.

The final engineered training datasets fuel accurate machine learning models for enhancing mortgage discrepancy detection with tailored Al intelligence.

The AI/ML subsystem 218 trains specialized machine learning models tailored to specific tasks within the mortgage discrepancy detection system 122. Appropriate algorithms may be selected based on factors like the problem type, available data, and performance requirements.

For predicting likelihood of mortgage violations, binary classification algorithms like logistic regression, random forests, and neural networks are suitable. The AI/ML subsystem 218 trains these on the engineered violation indicator features. Neural networks may capture complex nonlinear relationships. Random forests avoid overfitting. Logistic regression is fast and interpretable.

Public record query optimization may be framed as a regression task. Algorithms like linear regression, LASSO, and gradient-boosted regression tree may be trained on query performance data. Regression models predict optimal query parameter values.

Payment anomaly detection is a time-series classification problem. Recurrent neural networks like LSTMs and GRUs may be used to model sequential payment data. Time-series forecasting algorithms predict expected ranges.

Unsupervised learning via clustering analyzes raw public records to detect field correlations. K-means clustering groups similar records. PCA finds informative component dimensions.

The AI/ML subsystem 218 evaluates trained models on held-out test sets. Accuracy, precision, recall, F1 scores, AUC, confusion matrices, and loss metrics like MSE, cross-entropy, etc. may be used to increase model readiness. Models are retrained until validation metrics reach predefined thresholds.

This tailored, metrics-driven approach trains performant, purpose-built machine learning models that enhance mortgage discrepancy detection with specialized AI capabilities.

Once models are trained, the AI/ML subsystem 218 deploys them into production via integration with other system components to enhance functionality with predictive intelligence.

For example, a mortgage violation likelihood classifier is made available to the discrepancy analysis subsystem 208 via prediction APIs. When new public record discrepancies are detected, the discrepancy analysis subsystem 208 calls the classifier's API, passing the engineered features for that case. The API response provides the model-predicted likelihood that the discrepancies indicate a violation. This augments the tiering classification process with AI-driven probabilities.

Similarly, the public records query optimizer is integrated into the public records querying subsystem 206. The optimizer's API accepts proposed query parameters and returns optimized values for things like API selection, filter fields, and pagination. The public records querying subsystem 206 adapts its queries dynamically based on the optimized outputs.

Other trained models are integrated in a modular fashion. The payment anomaly detector flags high-risk payment records. The refinancing model forecasts optimal windows. The data imputer suggests missing value estimates.

Continuous model retraining pipelines keep the models accurate over time. Feedback loops pass back new training data like resolved investigations, query performance, updated payments. Periodic retraining maintains model lifecycle governance.

This modular, API-driven integration of machine learning models into downstream components enhances mortgage discrepancy detection with dynamic, tailored AI while keeping models maintainable. Tight coupling of ML with domain systems enables robust intelligence.

By leveraging the full pipeline, the AI/ML subsystem 218 seeks to deliver accurate AI enhancements. The tight integration of machine learning with the domain-focused mortgage discrepancy detection system provides robust, tailored intelligence that improves over time.

FIG. 21 illustrates further details of two example phases, namely a training phase 2104 (e.g., part of the model selection and trainings 2006) and a prediction phase 2110 (part of prediction 2010). Prior to the training phase 2104, feature engineering 2004 is used to identify features 2108. This may include identifying informative, discriminating, and independent features for effectively operating the trained machine-learning program 2102 in pattern recognition, classification, and regression. In some examples, the training data 2106 includes labeled data, known for pre-identified features 2108 and one or more outcomes. Each of the features 2108 may be a variable or attribute, such as an individual measurable property of a process, article, system, or phenomenon represented by a data set (e.g., the training data 2106). Features 2108 may also be of different types, such as numeric features, strings, and graphs, and may include one or more of content 2112, concepts 2114, attributes 2116, historical data 2118, and/or user data 2120, merely for example.

In training phase 2104, the machine-learning pipeline 2100 uses the training data 2106 to find correlations among the features 2108 that affect a predicted outcome or prediction/inference data 2122.

With the training data 2106 and the identified features 2108, the trained machine-learning program 2102 is trained during the training phase 2104 during machine-learning program training 2124. The machine-learning program training 2124 appraises values of the features 2108 as they correlate to the training data 2106. The result of the training is the trained machine-learning program 2102 (e.g., a trained or learned model).

Further, the training phase 2104 may involve machine learning, in which the training data 2106 is structured (e.g., labeled during preprocessing operations). The trained machine-learning program 2102 implements a neural network 2126 capable of performing, for example, classification and clustering operations. In other examples, the training phase 2104 may involve deep learning, in which the training data 2106 is unstructured, and the trained machine-learning program 2102 implements a deep neural network 2126 that can perform both feature extraction and classification/clustering operations.

In some examples, a neural network 226 may be generated during the training phase 2104, and implemented within the trained machine-learning program 2102. The neural network 2126 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 2126 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 2126 may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 2104, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In prediction phase 2110, the trained machine-learning program 2102 uses the features 2108 for analyzing query data 2128 to generate inferences, outcomes, or predictions, as examples of a prediction/inference data 2122. For example, during prediction phase 2110, the trained machine-learning program 2102 generates an output. Query data 2128 is provided as an input to the trained machine-learning program 2102, and the trained machine-learning program 2102 generates the prediction/inference data 2122 as output, responsive to receipt of the query data 2128.

In some examples, the trained machine-learning program 2102 may be a generative AI model. Generative AI is a term that may refer to any type of artificial intelligence that can create new content from training data 2106. For example, generative AI can produce text, images, video, audio, code, or synthetic data similar to the original data but not identical.

Some of the techniques that may be used in generative AI are:
Convolutional Neural Networks (CNNs): CNNs may be used for image recognition and computer vision tasks. CNNs may, for example, be designed to extract features from images by using filters or kernels that scan the input image and highlight important patterns.
Recurrent Neural Networks (RNNs): RNNs may be used for processing sequential data, such as speech, text, and time series data, for example. RNNs employ feedback loops that allow them to capture temporal dependencies and remember past inputs.
Generative adversarial networks (GANs): GNNs may include two neural networks: a generator and a discriminator. The generator network attempts to create realistic content that can “fool” the discriminator network, while the discriminator network attempts to distinguish between real and fake content. The generator and discriminator networks compete with each other and improve over time.
Variational autoencoders (VAEs): VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies.
Transformer models: Transformer models may use attention mechanisms to learn the relationships between different parts of input data (such as words or pixels) and generate output data based on these relationships. Transformer models can handle sequential data, such as text or speech, as well as non-sequential data, such as images or code.

In generative AI examples, the output prediction/inference data 222 includes predictions, translations, summaries, or media content.

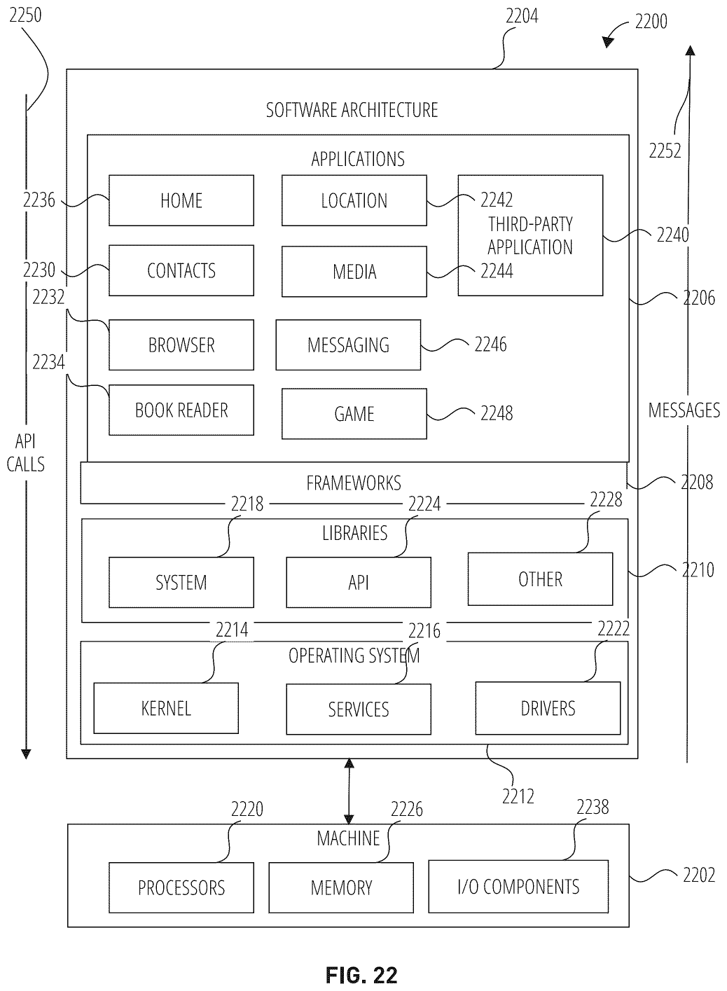

FIG. 22 is a block diagram 2200 illustrating a software architecture 2204, which can be installed on any one or more of the devices described herein. The software architecture 2204 is supported by hardware such as a machine 2202 that includes processors 2220, memory 2226, and I/O) components 2238. In this example, the software architecture 2204 can be conceptualized as a stack of layers, where each layer provides a particular functionality. The software architecture 2204 includes layers such as an operating system 2212, libraries 2210, frameworks 2208, and applications 2206. Operationally, the applications 2206 invoke API calls 2250 through the software stack and receive messages 2252 in response to the API calls 2250.

The operating system 2212 manages hardware resources and provides common services. The operating system 2212 includes, for example, a kernel 2214, services 2216, and drivers 2222. The kernel 2214 acts as an abstraction layer between the hardware and the other software layers. For example, the kernel 2214 provides memory management, Processor management (e.g., scheduling), component management, networking, and security settings, among other functionalities. The services 2216 can provide other common services for the other software layers. The drivers 2222 are responsible for controlling or interfacing with the underlying hardware. For instance, the drivers 2222 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, and power management drivers.

The libraries 2210 provide a low-level common infrastructure used by the applications 2206. The libraries 2210 can include system libraries 2218 (e.g., C standard library) that provide functions such as memory allocation functions, string manipulation functions, mathematic functions, and the like. In addition, the libraries 2210 can include API libraries 2224 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., Web Kit to provide web browsing functionality), and the like. The libraries 2210 can also include a wide variety of other libraries 2228 to provide many other APIs to the applications 2206.

The frameworks 2208 provide a high-level common infrastructure used by the applications 2206. For example, the frameworks 2208 provide various graphical user interface (GUI) functions, high-level resource management, and high-level location services. The frameworks 2208 can provide a broad spectrum of other APIs that can be used by the applications 2206, some of which may be specific to a particular operating system or platform.

In some examples, the applications 2206 may include a home application 2236, a contacts application 2230, a browser application 2232, a book reader application 2234, a location application 2242, a media application 2244, a messaging application 2246, a game application 2248, and a broad assortment of other applications such as a third-party application 2240. The applications 2206 are programs that execute functions defined in the programs. Various programming languages can be employed to create one or more of the applications 2206, structured in a variety of manners, such as object-oriented programming languages (e.g., Objective-C, Java, or C++) or procedural programming languages (e.g., C or assembly language). In a specific example, the third-party application 2240 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 2240 can invoke the API calls 2250 provided by the operating system 2212 to facilitate functionality described herein.

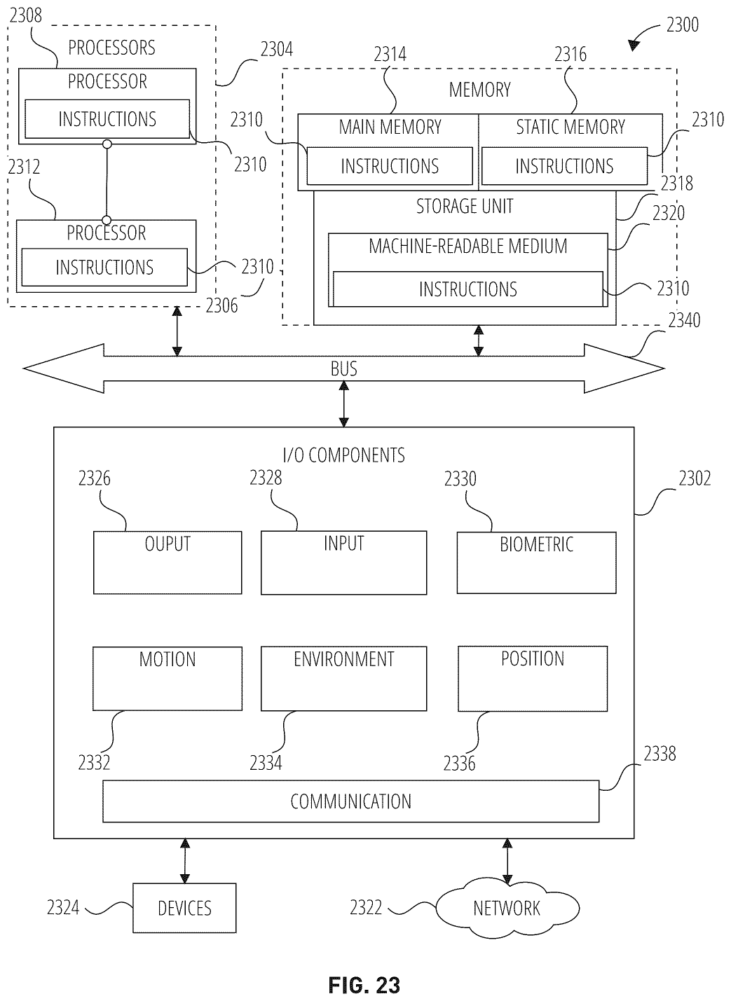

FIG. 23 is a diagrammatic representation of the machine 2300 within which instructions 2310 (e.g., software, a program, an application, an applet, an app, or other executable code) for causing the machine 2300 to perform any one or more of the methodologies discussed herein may be executed. For example, the instructions 2310 may cause the machine 2300 to execute any one or more of the methods described herein. The instructions 2310 transform the general, non-programmed machine 400 into a particular machine 2300 programmed to carry out the described and illustrated functions in the manner described. The machine 2300 may operate as a standalone device or be coupled (e.g., networked) to other machines. In a networked deployment, the machine 2300 may operate in the capacity of a server machine or a client machine in a server-client network environment, or as a peer machine in a peer-to-peer (or distributed) network environment. The machine 2300 may comprise, but not be limited to, a server computer, a client computer, a personal computer (PC), a tablet computer, a laptop computer, a netbook, a set-top box (STB), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 2310, sequentially or otherwise, that specify actions to be taken by the machine 2300. Further, while a single machine 2300 is illustrated, the term “machine” may include a collection of machines that individually or jointly execute the instructions 2310 to perform any one or more of the methodologies discussed herein.

The machine 2300 may include processors 2304, memory 2306, and I/O components 2302, which may be configured to communicate via a bus 2340. In some examples, the processors 2304 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application-Specific Integrated Circuit (ASIC), a Radio-Frequency Integrated Circuit (RFIC), another processor, or any suitable combination thereof) may include, for example, a processor 2308 and a processor 2312 that execute the instructions 2310. Although FIG. 23 shows multiple processors 2304, the machine 2300 may include a single processor with a single core, a single processor with multiple cores (e.g., a multi-core processor), multiple processors with a single core, multiple processors with multiples cores, or any combination thereof.

The memory 2306 comprises an example of a non-transitory computer-readable storage medium and includes a main memory 2314, a static memory 2316, and a storage unit 2318, both accessible to the processors 2304 via the bus 2340. The main memory 2306, the static memory 2316, and storage unit 2318 store the instructions 2310 embodying any one or more of the methodologies or functions described herein. The instructions 2310 may also reside, wholly or partially, within the main memory 2314, within the static memory 2316, within machine-readable medium 2320 within the storage unit 2318, within the processors 2304 (e.g., within the processor's cache memory), or any suitable combination thereof, during execution thereof by the machine 2300.

The I/O components 2302 may include various components to receive input, provide output, produce output, transmit information, exchange information, or capture measurements. The specific I/O components 2302 included in a particular machine depend on the type of machine. For example, portable machines such as mobile phones may include a touch input device or other such input mechanisms, while a headless server machine will likely not include such a touch input device. The I/O components 2302 may include many other components not shown in FIG. 23. In various examples, the I/O components 2302 may include output components 2326 and input components 2328. The output components 2326 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), or other signal generators. The input components 2328 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 2302 may include biometric components 2330, motion components 2332, environmental components 2334, or position components 2336, among a wide array of other components. For example, the biometric components 2330 include components to detect expressions (e.g., hand expressions, facial expressions, vocal expressions, body gestures, or eye-tracking), measure biosignals (e.g., blood pressure, heart rate, body temperature, perspiration, or brain waves), or identify a person (e.g., voice identification, retinal identification, facial identification, fingerprint identification, or electroencephalogram-based identification). The motion components 2332 include acceleration sensor components (e.g., accelerometer), gravitation sensor components, rotation sensor components (e.g., gyroscope). The environmental components 2334 include, for example, one or cameras, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 2336 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 2302 further include communication components 2338 operable to couple the machine 2300 to a network 2322 or devices 2324 via respective coupling or connections. For example, the communication components 2338 may include a network interface Component or another suitable device to interface with the network 2322. In further examples, the communication components 2338 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 2324 may be another machine or any of a wide variety of peripheral devices (e.g., a peripheral device coupled via a USB).

Moreover, the communication components 2338 may detect identifiers or include components operable to detect identifiers. For example, the communication components 2338 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Data glyph, Maxi Code, PDF417, Ultra Code, UCC RSS-2D bar code, and other optical codes), or acoustic detection components (e.g., microphones to identify tagged audio signals). In addition, a variety of information may be derived via the communication components 2338, such as location via Internet Protocol (IP) geolocation, location via Wi-Fi® signal triangulation, or location via detecting an NFC beacon signal that may indicate a particular location.

The various memories (e.g., main memory 2314, static memory 2316, and/or memory of the processors 2304) and/or storage unit 2318 may store one or more sets of instructions and data structures (e.g., software) embodying or used by any one or more of the methodologies or functions described herein. These instructions (e.g., the instructions 2310), when executed by processors 2304, cause various operations to implement the disclosed examples.

The instructions 2310 may be transmitted or received over the network 2322, using a transmission medium, via a network interface device (e.g., a network interface component included in the communication components 2338) and using any one of several well-known transfer protocols (e.g., hypertext transfer protocol (HTTP)). Similarly, the instructions 2310 may be transmitted or received using a transmission medium via a coupling (e.g., a peer-to-peer coupling) to the devices 2324.

### Method—Discrepancy Tracking

The computer-implemented method for detecting mortgage discrepancies is carried out by the automated mortgage discrepancy detection system 122 shown in FIG. 1

To ingest mortgage data, the data ingestion subsystem 204 receives mortgage data uploads from client devices 106. The upload handler of the data ingestion subsystem 204 validates the formats and values of the received mortgage data. The contract mapper then maps the validated mortgage data to the canonical data schema defined in the contracts table 302. The mapped mortgage data is stored in the contracts table 302 of the database 126

To periodically query public records, the public records querying subsystem 206 constructs API queries using mortgage identifiers to retrieve updated property records from third-party public data sources 130 via a third-party application 114. The public records querying subsystem 206 optimizes and tunes the API queries to increase efficiency and performance based on factors such as past query success rates and which specific public data sources contain the most up-to-date and complete data for properties in the client's portfolio.

The discrepancy analysis subsystem 208 compares the original mortgage terms from the contracts table 302 to the updated property records from the public records table 304 to identify discrepancies using robust field-by-field comparative logic. The comparative logic may implement techniques such as fuzzy matching and similarity scoring to identify even subtle discrepancies between mortgage terms and public records.

A tiering module of the discrepancy analysis subsystem 208 categorizes each mortgage into one of the plurality of tiers based on the identified discrepancies and predefined tiering rules, as discussed in detail with respect to FIG. 9. The tiers indicate the likelihood of a mortgage violation. The tiering rules may be calibrated based on feedback to accurately correlate assigned tiers with actual violation probabilities.

The user interface subsystem 202 generates a graphical user interface (e.g., refinance/renegotiation interface 1202) with a list of mortgages organized by tier, as displayed in FIG. 16A. Users can select a mortgage from the list via the user interface. The user interface allows filtering and sorting of the listed mortgages based on criteria such as tier, date, and estimated revenue to enable users to effectively prioritize high-value leads.

In response to the mortgage selection, the workflow subsystem 210 assigns the selected mortgage to a user for investigation by determining workload capacity utilizing algorithms to estimate availability based on assigned tasks. The mortgage is then assigned to a user with the lowest capacity, for example, or based on other criteria. Assignment rules can be configured to distribute leads based on factors like user expertise and geographic location.

The workflow subsystem 210 tracks the status of the selected mortgage as the user investigates by recording status changes in the active leads table 324. The status may be updated in real-time based on user actions. Status histories are appended to mortgage records to provide full audit trails.

Once the investigation is complete, the workflow subsystem 210 records the resolution result comprising renegotiated terms or a refinanced mortgage in the closure table 322. The closure table 322 maintains resolution details for aggregated reporting and analytics.

The data ingestion subsystem 204 also ingests payment data, and the discrepancy analysis subsystem 208 compares the latest payment to payment history to detect discrepancies. The tiering categorization may thus also be based on detected payment discrepancies. Payment data is protected via encryption.

The user interface subsystem 202 provides editable mortgage fields, using which user can edit mortgage data which updates the database 126. Changes are logged and mortgage versions are maintained.

The notification subsystem 212 generates notifications including assigned tiers based on configurable rules. Notifications may be delivered via channels like email and in-app messaging.

The workflow subsystem 210 generates visual workflow reports as discussed with reference to FIG. 11. The resolution report with resolution metrics is also generated. Reports provide insights like lead aging analysis.

The AI/ML subsystem 218 trains machine learning models on mortgage data. The trained models may categorize mortgages into tiers. Models are continuously retrained to improve accuracy.

The resolution result is exported and used to update mortgage terms in the database 126. Both renegotiated and refinanced mortgage details are recorded.

The tier explanations are generated and outline the specific triggers, applicable regulations, and recommendations.

The detailed technical implementation described above provides solutions to several key challenges in detecting mortgage discrepancies and violations. Specifically, the automated ingestion and normalization of disparate mortgage data formats solves the problem of efficiently consolidating fragmented records from diverse sources into a unified system. The application of optimized data storage, indexing, and querying architectures addresses the technical hurdle of performing fast joins and analysis across enormous datasets. The intelligent discrepancy detection and tiered prioritization algorithms provide a scalable solution for accurately identifying violations within vast portfolios. The customizable workflow systems and visual interfaces tackle the difficulty of managing and drawing insights from complex mortgage investigation data. The integration of machine learning enables continuous improvement of detection accuracy. Overall, the detailed technical approach delivers a comprehensive platform that leverages software and data engineering techniques to overcome multiple technical obstacles inherent in mortgage discrepancy analysis.

### Method—UI Generation

The refinance/renegotiation interfaces (e.g., the refinance/renegotiation interface 1202) discussed herein may be generated by the user interface subsystem 202. The list of mortgages organized by assigned tiers is displayed as shown in FIG. 16A and described in the specification.

The user selection of a mortgage is received via the user interface. In response, the workflow subsystem 210 retrieves the investigation data for the selected mortgage from the active leads table 324. The investigation data fields are described above.

The user interface subsystem 202 displays the retrieved investigation data in a graphical user interface. The side-by-side view of original and updated data is shown in FIG. 15. The chronological notes view is explained in the specification.

The user interface provides editable fields and status controls. These allow the user to update data and mark the mortgage as closed in the database 126.

The displayed mortgage list can be filtered and sorted using the controls shown in FIGS. 16A-16D. The filtering and sorting functionality is provided by the user interface subsystem 202.

The resolution review interface is displayed by the user interface subsystem 202. The user enters resolution details which are stored in the closure table 322. The status is updated in the active leads table 324.

The visual workflow report is generated by the workflow subsystem 210 and displayed by the user interface subsystem 202 as described with reference FIG. 11.

The layered discrepancy explanations are generated by the discrepancy analysis subsystem 208.

The AI/ML subsystem 218 trains a machine learning model that predicts the likelihood of violation and is used to assign tiers accordingly.

The user interface subsystem 202 calculates and displays monetary risks. Metrics are calculated based on mortgage terms and discrepancies identified.

OCR techniques can be used to extract mortgage data from scanned documents as described in the specification. The extracted OCR data is used to populate interface fields.

The refinance/renegotiation interfaces and associated systems described above deliver technical solutions to several challenges in managing contract discrepancy investigations. For example, the customizable filtering and sorting of violation leads by characteristics like severity and age addresses the difficulty of efficiently prioritizing cases for review. The consolidated display of original terms, updated records, discrepancies, and investigation history in a composite view addresses a problem of reviewing complex, disjointed data. The tracking of status changes and notes directly in the mortgage data repository addresses the technical challenge of fragmented audit trails. The machine learning-driven tiering assists with inconsistent and inaccurate manual categorization of violations. The calculation and display of monetary risks provides data-driven insights otherwise difficult to discern. Overall, the technical approach of robust interfaces tapping into comprehensive backend workflow, analytics, and machine learning systems solves key challenges around managing, understanding, and acting on mortgage discrepancies.

### Method—Data Validation Techniques to Improve Data Integrity During Mortgage Data Ingestion

The mortgage data ingestion system provides an automated and robust validation framework to ensure high-quality quality data enters the discrepancy detection system 122, according to some examples.

An API ingestion endpoint implemented in the Application Program Interface (API) server 118 provides the interface for external mortgage data sources to submit records to the detection system 122. This decouples the ingestion mechanism from the proprietary formats or schemas used by the multitude of contributing data sources.

An ingestion manager module orchestrates and controls flow through the multi-stage validation framework. In the first stage, a format validator module analyzes the structure of incoming records by parsing for expected fields and data columns. It validates that the records contain required identifying fields defined in the canonical contracts table schema used internally by the detection system 122. Records missing expected structural elements are rejected outright before further processing.

The second stage applies validations around data type formats and conventions. A decimal validator module extracts loan amount and interest rate percentage values and uses type casting, precision checking, and conditional logic to ensure adherence to predefined formats. Stringent format validation prevents downstream processing failures.

Text data fields are standardized by a text validator module using string manipulation operations like trimming, case conversion, and regex-based formatting. This normalization step removes extraneous variations that could affect meaning.

A reference data validator module validates codes and identifiers frequently found in mortgage data against permitted values constraints defined in lookup tables. Foreign key relationships are checked to ensure codes map to valid categories. Invalid codes are rectified to acceptable values.

Cross-record integrity checks are performed by the relational validator module which analyzes joined data between core tables like contracts and payments. Referential integrity rules are enforced, identifying orphaned or conflicting records.

Configurable business rules evaluate logical conditions and constraints on numeric data like loan-to-value ratios and debt-to-income ratios. The business rules validator module applies parameterized threshold rules tuned to detect outlier mortgage data.

Records passing validation stages are passed to the ingestion manager for insertion into the database 126 (e.g., a centralized PostgreSQL database). Records failing any validation are omitted from ingestion and alerts are generated to data providers by the notifications module.

This robust validation architecture processes mortgage data from diverse sources, ensuring high-quality, normalized data enters the discrepancy detection system, preventing downstream issues. The system can be extended to incorporate additional specialized validation modules as needed.

The robust validation techniques described address technical problems associated with ingesting fragmented, inconsistent mortgage data from diverse sources into a unified system. The use of schema validation, format standardization, relational integrity checks, and business rules validation provides a comprehensive technical solution to eliminate invalid, corrupted, or anomalous records that would degrade downstream processes. The application of type-specific validators at each stage of ingestion may address the challenge of normalizing heterogeneous data onto a common platform. Storing the validated records in a PostgreSQL architecture,, according to some examples, ensures efficient data management. Overall, the tiered validation approach provides adaptable and scalable technical means to consolidate, cleanse, and structure mortgage data from disparate systems into a standardized repository where it can be effectively utilized for discrepancy detection. The technical solutions address obstacles in ingesting real-world financial and contract data.

### Method—Optimized Data Storage and Indexing Schemes to Improve Public Records Query Performance

The mortgage data ingestion method, according to some examples, provides storage architectures and indexing techniques to enable efficient data management and retrieval.

An ingestion manager receives and validates incoming mortgage records, enriching data and staging validated records using the ingestion management module. The staged records are inserted into a database 126 (e.g., a PostgreSQL relational database table by the PostgreSQL data access module).

To optimize retrieval speed, a PostgreSQL indexing module defines B-tree index data structures on identifier fields expected to be common query criteria. The B-tree configuration may be tuned by setting node fill factors and leaf/non-leaf page sizes for ideal performance. The B-tree index is periodically reorganized by the indexing module to maintain efficiency as records scale.

The public records ETL scheduler periodically invokes the public records ETL process to retrieve updated property data related to mortgages from external databases. The retrieved public records are stored in distributed NoSQL database tables by the NoSQL data access module. A key-value structure provides scalability.

A NoSQL indexing module applies indexes on public records primary key fields corresponding to mortgage identifier fields.

A federated query engine module joins the relational contracts table and NoSQL public records tables by leveraging the unified indexes when queries are executed. It also filters joined records meeting query criteria and returns the results. Query operations are distributed across horizontally scaled NoSQL nodes by the NoSQL load balancer to enhance performance.

An analytics module generates aggregated metrics and visualizations by querying the relational and NoSQL data sources.

This multi-database architecture and indexing provides efficient storage and high-speed retrieval of mortgage data at scale.

The use of a relational database and/or a distributed database architecture provides a scalable and high-performance solution for managing large volumes of mortgage data, according to some examples. As mortgage records grow into the millions, relying on a single relational database table would cause ingestion and query bottlenecks. By distributing public records across NoSQL nodes, storage and throughput scales linearly with added capacity. The NoSQL load balancer provides the technical means to distribute query operations for efficient parallel processing. This solves the technical challenge of scaling to support enterprise-level mortgage data volumes.

The application of B-tree indexing, for example, on frequently filtered identifier fields enables fast data retrieval, providing a technical solution to slow query response times. As mortgage data accumulates, searching unsorted data could cause queries to degrade to linear scan operations, drastically slowing performance. The B-tree indexes allow the database to prune and selectively retrieve relevant subsets of records based on query criteria. Periodic reorganization maintains index performance despite a growing number of records. This addresses the technical problem of efficient data retrieval at scale.

The use of a federated query engine provides a unified interface to query across the relational contracts data and NoSQL public records data. Rather than requiring client applications to query each database in separate operations, the federated query engine may handle join operations across databases internally, providing a single integrated result set. This simplifies application development by abstracting away the complexities of distributed data sources.

Overall, the multi-database architecture, strategic indexing, and federated query engine provide technical improvements in the scalability, speed, and ease-of-use of mortgage data storage and retrieval systems compared to traditional approaches. The technical innovations deliver enhanced performance, capacity, and efficiency.

### Method—Formatting

An external data ingestion subsystem 204 receives heterogeneous mortgage data records with disparate formats from various external sources as input, according to some examples.

The data ingestion subsystem 204 analyzes the format of each incoming mortgage record to determine if it is in JSON, XML, CSV, or another proprietary format using data format detection logic.

Based on the detected format, a parsing dispatcher selects the appropriate parser module to extract loan term values from the record, as discussed above. JSON records may be parsed by the JSON parser, XML by the XML parser, and so on. The values are extracted without needing to interpret the external sources' proprietary data schemas.

A schema mapping module stores the canonical output schema defining standardized fields, data types, and value ranges for mortgage data. It maps the parsed loan values to the canonical schema fields, converting data types as needed. The converted records are used to populate mortgage data objects or tables defined according to the canonical schema class.

A relational storage module stores the populated mortgage objects in a standardized format in the PostgreSQL database, for example.

A REST API module allows remote user devices to query the database using parameterized API requests.

A query engine retrieves records matching the request parameters. The REST API response generator module compiles the results into a response containing the requested mortgage records in the standardized canonical format.

This may address a need for downstream systems to handle disparate formats, simplifying integration. The use of automated format detection and parser selection provides a scalable solution to ingesting heterogeneous mortgage data. Manually handling each external format may require resource-intensive custom integration. By automatically detecting formats and dispatching to appropriate parsers a new format may be added by plugging in another parser module. This enables flexible and cost-effective integration without requiring changes to the ingestion system code.

Mapping parsed data to a canonical schema seeks to address the problem of fragmented data silos. Rather than each external format resulting in a separate data silo, the canonical schema provides a unified representation. Mortgage records may conform to the same fields and formats regardless of source. This enables simplified downstream processing and analysis without having to handle disparate formats.

Storing the canonical data directly in the relational database 126 eliminates the need for transforming formats on retrieval. Traditional ETL processes may persist external formats requiring transformation at query time. By converting during ingestion, data can be directly queried and joined without transformation overhead. This seeks to address performance issues with analysis over heterogeneous sources.

The parameterized REST API abstraction enables efficient integration by external systems. Rather than requiring custom integration code for each client system, the API provides a universal interface for search and retrieval. New data consumers can integrate via simple API requests rather than complex custom code. This seeks to address the integration challenges of a proliferating technology landscape.

Overall, the technical solutions increase flexibility, interoperability, performance, and ease-of-use for enterprise mortgage data ingestion and management systems. The techniques handle diversity at scale.

### Method—Heterogeneous Data Record Data Ingestion

The data ingestion subsystem 204 provides an application programming interface (API) that can receive heterogeneous mortgage data records from diverse external sources, without needing to know the details of each source's proprietary data schema.

When mortgage records are received by the Application Program Interface (API) server 118, the data ingestion subsystem 204 analyzes them to determine their format, such as JSON, XML, CSV, or a custom format, using automated format detection logic. Based on the identified format, the parsing dispatcher selects the appropriate parser module to extract loan term values from the mortgage record. For example, a JSON parser would be used for a JSON document, an XML parser for an XML document, and so on. The values are extracted without needing to interpret or understand the external source's particular proprietary data schema.

A schema mapping module stores predefined mappings that define which standardized contract record fields correspond to the parsed loan term values. These mappings are used to programmatically insert the extracted values into the corresponding fields in the electronic mortgage contracts table 302, without requiring any manual entry by a user. This automated population of the contracts table 302 reduces risks of transcription errors that can occur with manual data entry.

The values may also be converted into a canonical standardized format by a schema mapping module before insertion into the contracts table 302. This enables contract records to be populated with external data without needing custom integration programming for every proprietary schema. The ingestion API and mapping module can handle arbitrary external schemas.

Finally, the populated electronic mortgage contract records containing the inserted loan term values are stored in the relational database 126 by a database storage module. This provides persistent and standardized storage of mortgage contracts for downstream processing and analysis.

The technical methods provide flexible, automated ingestion and normalization of mortgage data from diverse external sources without tight integration or manual processing.

### Method—Enhancing Mortgage Contract Records

The data ingestion subsystem 204, according to some examples, may initially ingest mortgage contract records containing loan terms into the database, as described in the specification.

The public records ETL process periodically retrieves updated property and ownership data related to the mortgages from external public record databases. The discrepancy analysis subsystem 208 compares the original contract data to the updated public records and identifies any differences between them. For each contract record, a contract enhancement module may enhance the record by appending additional data fields based on the identified discrepancies.

The additional fields include a list of the specific discrepancies found, such as differences in property value or owner name.

An assigned tier is added indicating the likelihood that the discrepancies represent a mortgage violation, based on predefined tier classification rules, as discussed in the specification.

A status field tracks where the contract record is in the investigation workflow, such as ‘assigned’ or ‘under review’, as stated in the specification.

A time log of status changes is appended, providing a timeline of events, as described in the specification.

Identifiers of users assigned to investigate the record are also added, as explained in the specification.

Further additional fields may be appended including original contract terms, updated public records, and investigation notes entered by users.

By augmenting records in this way, original contracts are transformed into enhanced contracts with appended data to facilitate investigation and resolution.

The user interface subsystem 202 provides interactive visual interfaces for users to view, edit, and update the enhanced records, as stated in the specification. Side-by-side comparisons, discrepancy views, notes editors, and status workflows are accessible through the user interface, as explained in the specification.

In summary, the technical approach dynamically enhances mortgage contracts with integrated discrepancy data, status tracking, and user assignments to enable streamlined investigation and management of public record conflicts.

### Method—Filtering Mortgage Leads

The user interface subsystem 202, according to some examples, displays interactive filter controls in a graphical user interface (e.g., refinance/renegotiation interface 1202) that allow users to configure filters for querying and extracting relevant leads from the lead data repository.

These configurable filter criteria include:
A status filter that filters leads based on their status category, such as ‘potential’, ‘investigating’, or ‘closing’. Users can select one or more status values to filter on.
A tier filter that filters leads based on their assigned tier indicating the likelihood of mortgage violation. Tiers include levels like ‘Tier 1’ or ‘Tier 2’. Users can filter leads by specific tiers of interest.
A user filter that filters leads based on which user or users they are assigned to for investigation. Useful for filtering a user's assigned leads.
A target filter that filters leads based on their designated target resolution type, such as ‘renegotiation’ or ‘refinance.’ Enables filtering leads by intended resolution path.

The filter controls include dropdown menus, sliders, and checkboxes that allow flexible configuration of filter criteria. Multiple filters can be combined.

When the user applies the configured filters, the user interface subsystem 202 extracts leads matching selected filter criteria from a lead repository (e.g., the contracts table 302) and refreshes the user interface to display the filtered leads.

The user interface subsystem 202 provides interactive sort controls that allow users to sort the filtered leads based on criteria like tier, discovery date, monetary value, and months remaining. The sort controls include dropdowns, buttons, and sliders, as stated in the specification.

The sorted leads meeting both filter and sort criteria are displayed in the refreshed user interface after sorting is applied.

As discussed in the specification, users can save frequently-used filter and sort configurations as preset views for rapid access. Controls in the interface allow applying these presets.

In summary, the advanced interactive filtering and sorting capabilities provide flexible lead prioritization and workflow efficiency for mortgage investigation management.

### EXAMPLES

Example 1 is a computer-implemented method for detecting mortgage data discrepancies, the method comprising: ingesting, into a database, mortgage data associated with a plurality of mortgages, the mortgage data comprising original mortgage terms; periodically querying one or more public record databases to retrieve updated property records associated with the plurality of mortgages; automatically comparing original mortgage terms to updated property records to identify discrepancies; automatically categorizing each mortgage into one of a plurality of tiers based on the identified discrepancies, each tier indicating a likelihood of a mortgage violation; generating, for display in a user interface, a list of mortgages organized by tier; receiving, via the user interface, a user selection of a mortgage from the list; in response to receiving the user selection, assigning the selected mortgage to a user for investigation; tracking a status of the selected mortgage as the user investigates the discrepancies; updating the status based on mortgage resolution activities by the user; and recording a resolution result comprising renegotiated mortgage terms or a refinanced mortgage.

In Example 2, the subject matter of Example 1 includes, ingesting payment data associated with the plurality of mortgages; and comparing a latest payment to a payment history to detect payment discrepancies; wherein categorizing each mortgage into one of the plurality of tiers is further based on detected payment discrepancies.

In Example 3, the subject matter of Examples 1-2 includes, wherein ingesting mortgage data further comprises: receiving mortgage data uploads from client devices; validating formats and values of the received mortgage data; mapping validated mortgage data to a canonical data schema; and storing mapped mortgage data in the database.

In Example 4, the subject matter of Examples 1-3 includes, wherein the tiers comprise: a first tier indicating a high likelihood of a mortgage violation; a second tier indicating potential for a future mortgage violation; and a third tier indicating no violation.

In Example 5, the subject matter of Examples 1-4 includes, generating notifications based on the identified discrepancies, the notifications comprising a summary of discrepancies and an assigned tier; and transmitting the notifications to assigned users based on notification rules.

In Example 6, the subject matter of Examples 1-5 includes, wherein assigning the selected mortgage comprises: determining a workload capacity of a plurality of users; and assigning the selected mortgage to a user with a lowest workload capacity.

In Example 7, the subject matter of Examples 1-6 includes, wherein tracking the status comprises: recording a timeline of status changes in a mortgage record; and updating the status in response to user actions on the selected mortgage.

In Example 8, the subject matter of Examples 1-7 includes, generating a visual workflow report comprising mortgage metrics aggregated by status; and providing the visual workflow report for display in the user interface.

In Example 9, the subject matter of Example 8 includes, wherein the mortgage metrics comprise a number of mortgages assigned to each user and time periods mortgages remain in each status.

In Example 10, the subject matter of Examples 1-9 includes, generating a resolution report comprising metrics associated with completed mortgage resolutions; and providing the resolution report for display in the user interface.

In Example 11, the subject matter of Example 10 includes, wherein the resolution metrics comprise a number of renegotiated mortgages, a number of refinanced mortgages, and profitability associated with the refinanced mortgages.

In Example 12, the subject matter of Examples 1-11 includes, training a machine learning model to predict a likelihood of a mortgage violation based on discrepancies; and utilizing the trained machine learning model to categorize each mortgage into one of the plurality of tiers.

In Example 13, the subject matter of Examples 1-12 includes, providing, for display in the user interface, editable mortgage fields; receiving user edits to the mortgage fields; and updating mortgage data in the database based on the received user edits.

In Example 14, the subject matter of Examples 1-13 includes, exporting the resolution result comprising the renegotiated or refinanced mortgage terms; and updating the original mortgage terms in the database based on the exported resolution result.

In Example 15, the subject matter of Examples 1-14 includes, wherein the tiers are associated with corresponding violation explanations comprising details of the identified discrepancies and reasoning for the assigned tier.

In Example 16, the subject matter of Examples 1-15 includes, identifying regulatory compliance issues based on the discrepancies; and generating alerts for users related to the identified regulatory compliance issues.' 16 is missing parent: 17. The computer-implemented method of Example 1, further comprising: calculating monetary risks and losses associated with the identified discrepancies; and providing calculated risk metrics with the listed mortgages in the user interface.' 16 is missing parent: 18. The computer-implemented method of claim 1, further comprising: generating a discrepancy audit trail documenting the identified discrepancies, assigned tier, and resolution details for each mortgage; and storing the audit trail to demonstrate regulatory compliance.

In Example 17, the subject matter of Examples 1-16 includes, integrating with external systems via APIs to automatically retrieve mortgage data and upload resolution details.

In Example 18, the subject matter of Examples 1-17 includes, utilizing blockchain technology to create immutable records of the mortgage data, identified discrepancies, and resolution details.

Example 19 is a computer-implemented method to display mortgage discrepancy data, the method comprising: displaying, in a graphical user interface, a list of mortgages with identified discrepancies between original mortgage data and updated public records, wherein the list organizes the mortgages by assigned tiers indicating a likelihood of mortgage violation; receiving a user selection of a mortgage from the displayed list; in response to the user selection, retrieving investigation data associated with the selected mortgage from a database, wherein the investigation data comprises original mortgage terms, updated public records, discrepancies, assigned tier, investigation notes, and resolution data; displaying the retrieved investigation data for the selected mortgage in the graphical user interface; and providing, in the graphical user interface, user interface elements enabling a user to view and edit the investigation data and mark the selected mortgage as closed based on resolution of identified discrepancies.

In Example 20, the subject matter of Example 19 includes, wherein displaying the list of mortgages comprises: filtering the mortgages based on assigned tier, user assignment, status, or target resolution type; sorting the filtered mortgages based on tier, discovery date, potential monetary value, or months remaining on mortgage; and generating graphical representations of the filtered and sorted mortgages in the graphical user interface.

In Example 19, the subject matter of Examples 19-20 includes, wherein displaying the investigation data comprises: displaying the original mortgage terms and updated public records in a side-by-side comparison view; displaying the discrepancies identified between the original mortgage terms and updated public records; and displaying a chronological view of investigation notes entered by users relating to the selected mortgage.

In Example 22, the subject matter of Examples 19-19 includes, in response to the user marking the mortgage as closed, displaying a resolution review interface for the user to enter details of a renegotiated mortgage or refinanced mortgage; receiving user entry of mortgage resolution details; storing the mortgage resolution details in the database linked to the selected mortgage; and updating the status of the selected mortgage to closed.

In Example 23, the subject matter of Examples 19-22 includes, displaying a visual workflow report comprising aggregate metrics based on mortgage status data from the database, wherein the workflow report comprises a number of mortgages assigned to each user and time periods mortgages remain in each status.

In Example 24, the subject matter of Examples 19-23 includes, generating a layered explanation for each identified discrepancy and assigned tier comprising reasoning extracted from predefined tier rules encoded in a rules engine.

In Example 25, the subject matter of Example 24 includes, wherein the layered

explanation comprises: a list of specific discrepancy triggers detected in the mortgage data; a description of scenarios indicated by the detected discrepancy triggers; applicable regulatory citations corresponding to the detected discrepancy triggers; potential exceptions that may preclude a mortgage violation; and recommended next actions for investigating the discrepancy.

In Example 26, the subject matter of Examples 19-25 includes, training a machine learning model on mortgage data and identified discrepancies; utilizing the trained machine learning model to predict a likelihood of violation for new mortgage data based on identified discrepancies; and assigning a tier to the new mortgage data based on the predicted likelihood of violation.

In Example 27, the subject matter of Examples 19-26 includes, calculating potential monetary risks and losses associated with identified discrepancies based on mortgage terms; and displaying the calculated monetary risks and losses associated with each mortgage in the graphical user interface.

In Example 28, the subject matter of Examples 19-27 includes, performing optical character recognition on scanned mortgage documents to extract mortgage data; and automatically populating fields of the displayed mortgage data with the optically recognized data.

Example 29 is a computer-implemented method for ingesting mortgage data, the method comprising: receiving, at an API endpoint, mortgage data records containing loan terms associated with a plurality of mortgages; validating the received mortgage data records by, parsing the data records and validating presence of required fields defined in a contracts table schema; extracting loan amount values from the data records and validating adherence to predefined decimal precision conventions; extracting interest rate percentage values from the data records and validating adherence to predefined decimal precision conventions; standardizing text data by removing extraneous characters and formatting using string manipulation functions; validating codes and identifiers against permitted values from reference database tables using foreign key constraints; joining the contracts table and payments table and validating referential integrity across related records; applying parameterized business logic rules evaluating loan-to-value ratios and debt-to-income ratios; and omitting any mortgage data records failing validation checks; storing the validated mortgage data records in a PostgreSQL relational database containing mortgage information.

In Example 30, the subject matter of Example 29 includes, wherein validating interest rate percentage values comprises: extracting an interest rate percentage string from a mortgage data record; converting the interest rate percentage string to a FLOAT data type numeric value; checking that the FLOAT value is within a permitted range using conditional logic; and representing the FLOAT value to a specified number of decimal places using data formatting functions.

In Example 29, the subject matter of Examples 29-30 includes, wherein validating codes and identifiers comprises: extracting codes and identifiers strings indicating property type, loan type, institution names, and regulatory designations from mortgage data records; passing the extracted codes and identifiers as foreign keys to query permitted values tables; modifying any invalid foreign keys to valid values based on matching against permitted values tables.

In Example 32, the subject matter of Examples 29-29 includes, wherein applying parameterized business logic rules comprises: determining loan-to-value ratios by dividing loan amounts by property valuations; calculating debt-to-income ratios by dividing borrower debt by income; comparing the calculated ratios to threshold values defined in business logic modules.

In Example 33, the subject matter of Examples 29-32 includes, generating alerts for mortgage data records failing validation checks; transmitting the alerts to client devices to indicate validation failures.

Example 34 is a computer-implemented method for storing mortgage data, the method comprising: ingesting mortgage data records comprising loan terms and identifiers associated with a plurality of mortgages; storing the mortgage data records in a relational database table; indexing the mortgage data records in the relational database table using a B-tree index data structure applied to one or more predefined identifier fields to optimize retrieval; periodically retrieving updated public records data related to the plurality of mortgages from one or more external databases; storing the updated public records data in one or more non-relational distributed NoSQL database tables as key-value pairs; indexing the NoSQL database tables on primary key fields corresponding to the one or more predefined identifier fields in the mortgage data records to optimize joining; upon receiving a query request, joining the relational database table and the NoSQL database tables using the indexes on the predefined identifier fields; retrieving mortgage data records and corresponding updated public records meeting query criteria; and returning the filtered joined data in response to the query request.

In Example 35, the subject matter of Example 34 includes, wherein ingesting mortgage data records further comprises: validating formats, ranges, and relational integrity of the mortgage data records; enriching the mortgage data records by deriving calculated fields to be indexed based on input data fields; and storing the validated, enriched mortgage data records in a staging area.

In Example 34, the subject matter of Examples 34-35 includes, wherein indexing the relational database table comprises: defining a B-tree index data structure on the predefined identifier fields expected to be highly-selective query criteria; applying techniques to optimize B-tree index performance including setting node fill factors and tuning leaf and non-leaf page sizes; periodically reorganizing the B-tree index to maintain efficient data access as new mortgage records are ingested.

In Example 37, the subject matter of Examples 34-34 includes, wherein joining the relational and NoSQL database tables comprises: load balancing query operations across a horizontally scaled NoSQL database architecture; leveraging the indexes on the predefined identifier fields to perform fast indexed joins between the relational table and distributed NoSQL tables.

In Example 38, the subject matter of Examples 34-37 includes, providing an analytics layer that interacts with the relational and NoSQL databases to generate aggregated metrics and visualizations of mortgage data queried across databases.

Example 39 is a computer-implemented method for standardized formatting of mortgage data, the method comprising: receiving, at a server, mortgage data records comprising loan terms from a plurality of external data sources, the mortgage data records having disparate data formats; storing code for defining a canonical data schema; analyzing the received mortgage data records to determine their original data formats and extract loan term values; converting the extracted loan term values from their original data formats into the canonical data schema; storing the converted mortgage data records in standardized format in a relational database; allowing remote user devices to submit queries for mortgage data records; retrieving mortgage data records meeting the received query parameters, generating a response comprising the retrieved mortgage data records in the standardized format defined by the canonical data schema; and transmitting the response to the remote user devices, wherein the standardized format of the mortgage data records enables the remote user devices to process the mortgage data records more efficiently by eliminating the need to convert disparate data formats.

In Example 40, the subject matter of Example 39 includes, wherein analyzing the received mortgage data records comprises: determining whether a mortgage data record is in JSON format, XML format, CSV format, or proprietary format; selecting an appropriate parser based on the determined data format; and extracting loan term values from the mortgage data record using the selected parser.

In Example 39, the subject matter of Examples 39-40 includes, wherein converting the extracted loan term values comprises: mapping the extracted loan term values to corresponding fields defined in the canonical data schema; converting data types of the extracted values to match the canonical data schema; and populating instances of a class defining the canonical data schema with the converted loan term values.

In Example 42, the subject matter of Examples 39-39 includes, wherein the remote user devices process the received mortgage data records by: ingesting the data records without needing to convert from disparate formats; storing the data records directly into a local database; and performing analysis on the data records to generate results and visualizations.

In Example 43, the subject matter of Examples 39-42 includes, wherein the canonical data schema defines expected data fields, data types, and value ranges for mortgage data in a standardized format.

In Example 44, the subject matter of Example undefined includes, wherein customizing the canonical data schema comprises: adding one or more new data fields representing proprietary information tracked by a particular remote user device; defining a required data type and format for the added proprietary data fields; such that mortgage data records are converted to the customized schema format containing the proprietary fields when transmitted to the particular remote user device.

In Example 45, the subject matter of Examples 39-44 includes, validating the extracted loan term values against a set of predefined business rules prior to converting into the canonical data schema; wherein validating comprises checking that numeric values fall within specified ranges, text values match permitted terms, and logical relationships between values are maintained.

In Example 46, the subject matter of Examples 39-45 includes, tracking data quality metrics for received mortgage data records, the metrics indicating frequencies of missing values, invalid formats, or failed validation checks; generating data quality reports based on the tracked metrics; and transmitting the data quality reports to provide feedback to the external data sources regarding conformance to the canonical data schema.

In Example 47, the subject matter of Examples 39-46 includes, applying predictive machine learning techniques to train a model that suggests mappings from disparate data formats to the canonical data schema based on identifying patterns and correlations in previously ingested mortgage data records.

Example 48 is a computer-implemented method for detecting mortgage discrepancies, the method comprising: ingesting, into a database, mortgage data associated with a plurality of mortgages, the mortgage data comprising original mortgage terms; periodically querying one or more public record databases to retrieve updated property records associated with the plurality of mortgages; comparing, by a discrepancy detection module, original mortgage terms to updated property records to identify discrepancies; categorizing, by a tiering module, each mortgage into one of a plurality of tiers based on the identified discrepancies, each tier indicating a likelihood of a mortgage violation; generating, for display in a user interface, a list of mortgages organized by tier; receiving, via the user interface, a user selection of a mortgage from the list; in response to receiving the user selection, assigning the selected mortgage to a user for investigation; tracking a status of the selected mortgage as the user investigates the discrepancies; updating the status based on mortgage resolution activities by the user; and recording a resolution result comprising renegotiated mortgage terms or a refinanced mortgage.

In Example 49, the subject matter of Example 48 includes, ingesting payment data associated with the plurality of mortgages; and comparing a latest payment to a payment history to detect payment discrepancies; wherein categorizing each mortgage into one of the plurality of tiers is further based on detected payment discrepancies.

In Example 50, the subject matter of Examples 48-49 includes, wherein ingesting mortgage data further comprises: receiving mortgage data uploads from client devices; validating formats and values of the received mortgage data; mapping validated mortgage data to a canonical data schema; storing mapped mortgage data in the database.

In Example 48, the subject matter of Examples 48-50 includes, wherein the tiers comprise: a first tier indicating a high likelihood of a mortgage violation; a second tier indicating potential for a future mortgage violation; and a third tier indicating no violation.

In Example 52, the subject matter of Examples 48-48 includes, generating notifications based on the identified discrepancies, the notifications comprising a summary of discrepancies and an assigned tier; and transmitting the notifications to assigned users based on notification rules.

In Example 53, the subject matter of Examples 48-52 includes, wherein assigning the selected mortgage comprises: determining a workload capacity of a plurality of users; and assigning the selected mortgage to a user with a lowest workload capacity.

In Example 54, the subject matter of Examples 48-53 includes, wherein tracking the status comprises: recording a timeline of status changes in a mortgage record; and updating the status in response to user actions on the selected mortgage.

In Example 55, the subject matter of Examples 48-54 includes, generating a visual workflow report comprising mortgage metrics aggregated by status; and providing the visual workflow report for display in the user interface.

In Example 56, the subject matter of Example 55 includes, wherein the mortgage metrics comprise a number of mortgages assigned to each user and time periods mortgages remain in each status.

In Example 57, the subject matter of Examples 48-56 includes, generating a resolution report comprising metrics associated with completed mortgage resolutions; and providing the resolution report for display in the user interface.

In Example 58, the subject matter of Example 57 includes, wherein the resolution metrics comprise a number of renegotiated mortgages, a number of refinanced mortgages, and profitability associated with the refinanced mortgages.

Example 59 is a computer-implemented method for ingesting mortgage data, the method comprising: providing an application programming interface (API) configured to receive mortgage data records from an external sources having disparate proprietary data schemas unknown to the API; analyzing the received mortgage data records to extract loan term values without needing knowledge of the proprietary data schemas; mapping the extracted loan term values to a canonical data schema; populating electronic mortgage contract records with the mapped loan term values by inserting the values into corresponding predefined contract records fields without requiring manual entry; and storing the populated mortgage contract records containing the inserted loan term values in a database.

In Example 60, the subject matter of Example 59 includes, wherein analyzing the received mortgage data records comprises: determining a data format of a mortgage data record; selecting an appropriate parser based on the determined data format; extracting loan term values from the mortgage data record using the selected parser without needing knowledge of the proprietary data schema u rises: retrieving mappings that define contract records fields corresponding to the loan term values; and programmatically inserting the loan term values into the corresponding electronic mortgage contract records fields without requiring user entry.

In Example 61, the subject matter of Example 60 includes, wherein programmatically inserting the loan term values eliminates risks of transcription errors.

In Example 59, the subject matter of Examples 59-61 includes, wherein the electronic mortgage contract records are populated with the loan term values without needing custom programming for each external source's proprietary data schema.

In Example 63, the subject matter of Examples 59-59 includes, wherein the extracted loan term values are converted to a standardized canonical format prior to insertion into the electronic mortgage contract records.

Example 64 is a computer-implemented method for enhancing mortgage contract records, the method comprising: ingesting a plurality of mortgage contract records into a database, each contract record comprising loan terms associated with a mortgage; periodically retrieving updated public records data related to the plurality of mortgages; comparing the public records data to the contract records to identify discrepancies; and for each contract record, enhancing the record by appending additional data fields based on the identified discrepancies; wherein the additional data fields comprise: a list of the identified discrepancies; an assigned tier indicating a likelihood of mortgage violation based on the discrepancies; a status field tracking investigation status of the contract record; a time log of status changes; and identifiers of users assigned to investigate the contract record.

In Example 65, the subject matter of Example 64 includes, wherein the additional data fields further comprise: original mortgage terms; updated public records data; investigation notes entered by assigned users related to the contract record.

In Example 66, the subject matter of Examples 64-65 includes, wherein enhancing the contract records comprises: transforming the original contract records into enhanced contract records by appending the additional data fields in a predetermined format.

In Example 67, the subject matter of Example 66 includes, wherein the predetermined format defines a data schema for the enhanced contract records.

In Example 68, the subject matter of Examples 64-64 includes, providing a graphical user interface for accessing and interacting with the enhanced contract records.

In Example 69, the subject matter of Example 68 includes, wherein the graphical user interface enables users to: view the original contract terms and updated public records in a side-by-side comparison; view the identified discrepancies and assigned tier; view a chronological list of investigation notes; edit investigation notes; change investigation status.

Example 70 is a computer-implemented method for filtering mortgage leads, the method comprising: displaying, in a graphical user interface, filter controls enabling user configuration of lead filters; receiving user input via the filter controls selecting one or more lead filters, wherein the lead filters comprise: a status filter for filtering leads based on status categories of potential, investigating, or closing; a tier filter for filtering leads based on assigned tiers indicating likelihood of mortgage violation; a user filter for filtering leads based on assignment to specific users; a target filter for filtering leads based on designated target resolution types of renegotiation or refinance; applying the selected lead filters to a lead data repository to extract leads matching the selected filters; and displaying the filtered leads in the graphical user interface.

In Example 71, the subject matter of Example 70 includes, wherein the filter controls comprise dropdown elements to select filter criteria, sliders to set filter ranges, and checkboxes to toggle filters on or off.

In Example 72, the subject matter of Examples 70-71 includes, displaying, in the graphical user interface, sort controls enabling user configuration of lead sorting; receiving user input via the sort controls selecting one or more sort criteria, wherein the sort criteria comprise: tier; date discovered; estimated monetary value; months remaining; sorting the filtered leads based on the selected sort criteria; and displaying the filtered and sorted leads in the graphical user interface.

In Example 73, the subject matter of Example 72 includes, wherein the sort controls comprise dropdown elements to select sort fields, buttons to toggle sort direction, and sliders to set weighting of sort criteria.

In Example 74, the subject matter of Examples 70-70 includes, saving user-configured filter and sort criteria as preset views; displaying controls in the graphical user interface to apply saved preset views to rapidly filter and sort leads.

Example 75 is a computer-implemented method for navigating mortgage data interfaces, the method comprising: displaying a navigation menu in a graphical user interface comprising selectable menu items corresponding to different mortgage data pages; generating a statistics summary section in the graphical user interface that displays key metrics and performance indicators related to mortgage data; receiving a user selection of a menu item; in response to the user selection, retrieving mortgage data for the selected menu page from a database; generating the selected menu page comprising the retrieved mortgage data; and displaying the generated menu page in the graphical user interface.

In Example 76, the subject matter of Example 75 includes, wherein the menu items comprise menu items corresponding to: an Overview page comprising a main summary dashboard page; a Refinances page comprising a page tracking and reporting on refinances; a Renegotiations page comprising a page tracking and reporting on renegotiations; and an Active Leads page comprising a page to manage leads workflow.

In Example 77, the subject matter of Examples 75-76 includes, wherein the menu pages comprise: a quarterly breakdown section displaying summarized statistics for a current quarter, previous quarter, and progress percentage; a statistics summary section displaying key metrics and performance indicators; a main data section displaying visualizations of primary mortgage data.

In Example 78, the subject matter of Example 77 includes, wherein the quarterly breakdown section comprises: closed refinances for the current quarter; closed refinances for the previous quarter; percentage progress through the current quarter based on historical data.

In Example 79, the subject matter of Examples 77-78 includes, wherein the statistics summary section comprises: total number of closed refinances; percentage contribution to total team refinances; total profit dollars earned; percentage contribution to total team profits.

Example 80 is a computer-implemented method for generating composite mortgage interfaces, the method comprising: retrieving first mortgage data relating to a mortgage lead from a database, wherein the first mortgage data comprises original loan terms; retrieving second mortgage data relating to the mortgage lead from the database, wherein the second mortgage data comprises updated property records; generating a first interface section displaying the original loan terms from the first mortgage data; generating a second interface section displaying the updated property records from the second mortgage data; analyzing the first and second mortgage data to identify discrepancies; generating a third interface section displaying the identified discrepancies; combining the first, second, and third interface sections into a composite interface; and displaying the composite interface in a graphical user interface.

In Example 81, the subject matter of Example 80 includes, wherein the first and second interface sections display the first and second mortgage data in a side-by-side comparison view.

In Example 82, the subject matter of Examples 80-81 includes, generating a fourth interface section displaying a chronological list of investigation notes associated with the mortgage lead; and combining the fourth interface section into the composite interface.

In Example 80, the subject matter of Examples 80-82 includes, providing controls in the graphical user interface enabling user interaction with the composite interface, wherein the controls allow users to: view and edit investigation notes; change investigation status of the mortgage lead; update mortgage data fields.

In Example 84, the subject matter of Examples 80-80 includes, wherein analyzing the first and second mortgage data comprises: applying tier classification rules to categorize likelihood of mortgage violation based on identified discrepancies; generating an assigned tier indicator as part of the third interface section.

Example 85 is at least one non-transitory machine-readable medium including instructions that, when executed by processing circuitry, cause the processing circuitry to perform operations to implement any of Examples 1-84.

Example 86 is an apparatus comprising means to implement of any of Examples 1-84.

Example 87 is a system to implement of any of Examples 1-84.

Example 88 is a method to implement of any of Examples 1-84.

1. A computer-implemented method for detecting data discrepancies, the computer-implemented method comprising:
ingesting, into a database, mortgage data associated with a plurality of mortgages, the mortgage data comprising original mortgage terms, the ingesting the mortgage data comprising:
encrypting a subset of the mortgage data;
identifying non-conforming mortgage data among the mortgage data;
excluding the non-conforming mortgage data from the mortgage data to obtain validated mortgage data, the validated mortgage data comprising the encrypted subset of the mortgage data; and
mapping the validated mortgage data to a canonical data schema to generate canonical original mortgage terms, the canonical data schema being comprised of expected data fields, data types, and value ranges, the mapping comprising:
decrypting the encrypted subset of the mortgage data using an asymmetric key;
inserting the decrypted subset of the mortgage data to the canonical original mortgage terms; and
re-encrypting, using the asymmetric key, the decrypted subset of the mortgage data inserted in the canonical original mortgage terms;
periodically querying one or more public record databases to retrieve updated property records associated with the plurality of mortgages via an API endpoint, the periodically querying comprising mapping the updated property records returned by the API endpoint to the canonical data schema to generate canonical updated property records corresponding to the canonical original mortgage terms;
automatically and using at least one processor, comparing the canonical original mortgage terms to the canonical updated property records to identify discrepancies;
automatically categorizing each mortgage of the plurality of mortgages into one of a plurality of tiers of risks associated with likelihoods of a mortgage violation based on the identified discrepancies, the categorizing comprising using a predefined set of rules to map a plurality of discrepancy triggers to respective tiers of the plurality of tiers;
generating, for display in a user interface, a list of mortgages organized by tiers of the plurality of tiers;
receiving, via the user interface, a user selection of a selected mortgage from the list of mortgages;
in response to receiving the user selection, assigning the selected mortgage to a user for investigation;
generating a notification to inform the user of the assignment of the selected mortgage;
transmitting the notifications to the user based on notification rules;
tracking a status of the selected mortgage as the user investigates the identified discrepancies in the database;
updating the status based on mortgage resolution activities by the user; and
recording a resolution result comprising at least one of renegotiated mortgage terms or a refinanced mortgage.

2. The computer-implemented method of claim 1, further comprising:
ingesting payment data associated with the plurality of mortgages; and
comparing a latest payment to a payment history to detect payment discrepancies;
wherein categorizing each mortgage of the plurality of mortgages into the one of the plurality of tiers is further based on the detected payment discrepancies.

3. (canceled)

4. The computer-implemented method of claim 1, wherein the plurality of tiers comprise:
a first tier indicating a first likelihood of a current mortgage violation;
a second tier indicating a second likelihood of a future mortgage violation; and
a third tier indicating no current mortgage violation.

5. (canceled)

6. The computer-implemented method of claim 1, wherein assigning the selected mortgage comprises:
determining respective workload capacities of a plurality of users; and
assigning the selected mortgage to the user based on a workload capacity of the user.

7. The computer-implemented method of claim 1, further comprising:
generating a visual workflow report comprising mortgage metrics aggregated by status; and
providing the visual workflow report for display in the user interface,
wherein the mortgage metrics comprise a number of mortgages assigned to each user and time periods mortgages remain in each status.

8. The computer-implemented method of claim 1, further comprising:
generating a resolution report comprising metrics associated with completed mortgage resolutions; and
providing the resolution report for display in the user interface,
wherein the resolution metrics comprise at least one of a number of renegotiated mortgages, a number of refinanced mortgages, or profitability associated with the refinanced mortgages.

9. The computer-implemented method of claim 1, further comprising:
training a machine learning model to predict a likelihood of a mortgage violation based on discrepancies; and
utilizing the trained machine learning model to categorize each mortgage of the plurality of mortgages into one of the plurality of tiers.

10. The computer-implemented method of claim 1, further comprising:
providing, for display in the user interface, editable mortgage fields;
receiving user edits to the mortgage fields; and
updating the mortgage data in the database based on the received user edits.

11. The computer-implemented method of claim 1, further comprising:
exporting the resolution result comprising the renegotiated or refinanced mortgage terms; and
updating the original mortgage terms in the database based on the exported resolution result.

12. The computer-implemented method of claim 1, further comprising:
identifying regulatory compliance issues based on the discrepancies; and
generating alerts for users related to the identified regulatory compliance issues.

13. The computer-implemented method of claim 1, further comprising:
calculating monetary risks and losses associated with the identified discrepancies; and
providing calculated risk metrics with the listed mortgages in the user interface.

14. The computer-implemented method of claim 1, further comprising:
generating a discrepancy audit trail documenting the identified discrepancies, assigned tier, and resolution details for each mortgage; and
storing the audit trail to demonstrate regulatory compliance in the database.

15. The computer-implemented method of claim 1, further comprising:
integrating with external systems via APIs to automatically retrieve the mortgage data and upload resolution details.

16. The computer-implemented method of claim 1, further comprising:
utilizing blockchain technology to create immutable records of the mortgage data, identified discrepancies, and resolution details.

17. The computer-implemented method of claim 1, further comprising:
retrieving investigation data associated with the selected mortgage from the database, wherein the investigation data comprises the original mortgage terms, updated public records, discrepancies, assigned tier, investigation notes, and resolution data;
displaying the retrieved investigation data for the selected mortgage in the user interface; and
providing, in the user interface, user interface elements enabling the user to view and edit the investigation data and mark the selected mortgage as closed based on resolution of identified discrepancies.

18. The computer-implemented method of claim 15, wherein the excluding the non-conforming mortgage data from the mortgage data to obtain validated mortgage data comprising:
extracting loan amount values from the data records and validating adherence to predefined decimal precision conventions;
extracting interest rate percentage values from the data records and validating adherence to the predefined decimal precision conventions;
standardizing text data by removing extraneous characters and formatting using string manipulation functions;
validating codes and identifiers against permitted values from reference database tables using foreign key constraints;
applying parameterized business logic rules evaluating loan-to-value ratios and debt-to-income ratios;
omitting failed mortgage data failing validation checks; and
storing validated mortgage data in the database.

19. A computing apparatus comprising:
at least one processor; and
at least one memory storing instructions that, when executed by the at least one processor, configure the apparatus to perform operations comprising:
ingesting, into a database, mortgage data associated with a plurality of mortgages, the mortgage data comprising original mortgage terms, the ingesting the mortgage data comprising:
encrypting a subset of the mortgage data;
identifying non-conforming mortgage data among the mortgage data;
excluding the non-conforming mortgage data from the mortgage data to obtain validated mortgage data, the validated mortgage data comprising the encrypted subset of the mortgage data; and
mapping the validated mortgage data to a canonical data schema to generate canonical original mortgage terms, the canonical data schema being comprised of expected data fields, data types, and value ranges, the mapping comprising:
decrypting the encrypted subset of the mortgage data using an asymmetric key;
inserting the decrypted subset of the mortgage data to the canonical original mortgage terms; and
re-encrypting, using the asymmetric key, the decrypted subset of the mortgage data inserted in the canonical original mortgage terms;
periodically querying one or more public record databases to retrieve updated property records associated with the plurality of mortgages via an API endpoint, the periodically querying comprising mapping the updated property records returned by the API endpoint to the canonical data schema to generate canonical updated property records corresponding to the canonical original mortgage terms;
automatically and using at least one processor, comparing the canonical original mortgage terms to the canonical updated property records to identify discrepancies;
automatically categorizing each mortgage of the plurality of mortgages into one of a plurality of tiers of risks associated with likelihoods of a mortgage violation based on the identified discrepancies, the categorizing comprising using a predefined set of rules to map a plurality of discrepancy triggers to respective tiers of the plurality of tiers;
generating, for display in a user interface, a list of mortgages organized by tiers of the plurality of tiers;
receiving, via the user interface, a user selection of a selected mortgage from the list of mortgages;
in response to receiving the user selection, assigning the selected mortgage to a user for investigation;
generating a notification to inform the user of the assignment of the selected mortgage;
transmitting the notifications to the user based on notification rules;
tracking a status of the selected mortgage as the user investigates the identified discrepancies in the database;
updating the status based on mortgage resolution activities by the user; and
recording a resolution result comprising at least one of renegotiated mortgage terms or a refinanced mortgage.

20. A non-transitory computer-readable storage medium, the computer-readable storage medium including instructions that when executed by at least one computer, cause the at least one computer to perform operations comprising:
ingesting, into a database, mortgage data associated with a plurality of mortgages, the mortgage data comprising original mortgage terms, the ingesting the mortgage data comprising:
encrypting a subset of the mortgage data;
identifying non-conforming mortgage data among the mortgage data;
excluding the non-conforming mortgage data from the mortgage data to obtain validated mortgage data, the validated mortgage data comprising the encrypted subset of the mortgage data; and
mapping the validated mortgage data to a canonical data schema to generate canonical original mortgage terms, the canonical data schema being comprised of expected data fields, data types, and value ranges, the mapping comprising:
decrypting the encrypted subset of the mortgage data using an asymmetric key;
inserting the decrypted subset of the mortgage data to the canonical original mortgage terms; and
re-encrypting, using the asymmetric key, the decrypted subset of the mortgage data inserted in the canonical original mortgage terms;
periodically querying one or more public record databases to retrieve updated property records associated with the plurality of mortgages via an API endpoint, the periodically querying comprising mapping the updated property records returned by the API endpoint to the canonical data schema to generate canonical updated property records corresponding to the canonical original mortgage terms;
automatically and using at least one processor, comparing the canonical original mortgage terms to the canonical updated property records to identify discrepancies;
automatically categorizing each mortgage of the plurality of mortgages into one of a plurality of tiers of risks associated with likelihoods of a mortgage violation based on the identified discrepancies, the categorizing comprising using a predefined set of rules to map a plurality of discrepancy triggers to respective tiers of the plurality of tiers;
generating, for display in a user interface, a list of mortgages organized by tiers of the plurality of tiers;
receiving, via the user interface, a user selection of a selected mortgage from the list of mortgages;
in response to receiving the user selection, assigning the selected mortgage to a user for investigation;
generating a notification to inform the user of the assignment of the selected mortgage;
transmitting the notifications to the user based on notification rules;
tracking a status of the selected mortgage as the user investigates the identified discrepancies in the database;
updating the status based on mortgage resolution activities by the user; and
recording a resolution result comprising at least one of renegotiated mortgage terms or a refinanced mortgage.
